(19) United States
(12) Patent Application Publication
(10) Pub. No.: US 2022/0025268 A1
(43) Pub. Date: Jan. 27, 2022

(54) FLAME-RETARDANT MIXTURES, FLAME-RETARDING POLYMER COMPOSITIONS, CABLE EQUIPPED THEREWITH AND USE THEREOF

(71) Applicant: CLARIANT INTERNATIONAL LTD, Muttenz (CH)

(72) Inventors: Harald BAUER, Kerpen (DE); Sebastian HOEROLD, Diedorf (DE); Bernd NASS, Augsburg (DE); Elke SCHLOSSER, Augsburg (DE); Martin SICKEN, Köln (DE)

(73) Assignee: CLARIANT INTERNATIONAL LTD, Muttenz (CH)

(21) Appl. No.: 17/297,009

(22) PCT Filed: Nov. 28, 2019
(86) PCT No.: PCT/EP2019/082913

§ 371 Date: May 26, 2021

(30) Foreign Application Priority Data
Nov. 30, 2018 (DE) 10 2018 220 696.1

(51) Int. Cl. C09K 21/12; C09K 21/04; H01B 7/295; C08L 75/04; C08L 23/12

(52) U.S. Cl. CPC C09K 21/12; C09K 21/04; C08L 2201/02; C08L 75/04; C08L 23/12; H01B 7/295

(57) ABSTRACT

Flame-retardant mixtures containing: a) salt of phosphinic acid of formula (I), wherein R1 and R2 mean, independently of each other, alkyl-, cycloalkyl-, aryl- or aralkyl, substituted as applicable, M is m-valent cation, and m means 1 to 4, b) salt of phosphinic acid of formula (II), differing from component a), wherein R3 means substituted, as applicable, alkyl-, cycloalkyl-, cycloalkyl-alkyl, aryl- or aralkyl, preferably with alkyl radicals as substituents, R4 is alkyl having even number of carbon atoms (if R1 and/or R2 are alkyl, R4 has double, triple or quadruple the number of carbon atoms of R1 or R2), M is n-valent cation and n means 1 to 4, c) organylphosphonate, d) phosphite, e) as applicable, a representative selected from the group consisting of triazine complex, polyphosphate, hypophosphite, nitrogenous diphosphate, organophosphate, phosphazene and/or polyphosphonate, f) as applicable, a representative selected from the group consisting of metal hydroxide, metal carbonate, metal borate, zinc stannate and/or intumescence additive, and g) as applicable, pigment, wherein at least one of components e) and/or f) must be present in the mixture. The mixtures can use thermoplastic and elastomeric polymers to produce flame-retardant polymer compositions, which are exceptionally suitable for producing cable sheathing or cable insulation.

The present invention relates to preferably halogen-free flame retardant mixtures, to flame-retardant polymer compositions, and to insulated cables endowed with the flame-retardant polymer formulation.

Plastics generally have to be equipped with flame retardants in order to be able to attain the high flame retardancy demands made by the plastics processors and in some cases by the legislator. Preferably—for environmental reasons as well—nonhalogenated flame retardant systems that form only a low level of smoke gases, if any, are used.

Among these flame retardants, the salts of phosphinic acids (phosphinates) have been found to be particularly effective for thermoplastic polymers (DE 2 252 258 A and DE 2 447 727 A).

In addition, there are known synergistic combinations of phosphinates with particular nitrogen-containing compounds which have been found to be more effective as flame retardants in a whole series of polymers than the phosphinates alone (WO-2002/28953 A1, and also DE 197 34 437 A1 and DE 197 37 727 A1).

U.S. Pat. No. 7,420,007 B2 discloses that dialkylphosphinates containing a small amount of selected telomers as flame retardant are suitable for polymers, the polymer being subject only to quite a minor degree of degradation on incorporation of the flame retardant into the polymer matrix.

DE 10 2014 001 222 A1 discloses flame retardant mixtures comprising salts of dialkylphosphinic acid, telomers, organylphosphonate and phosphite, and additionally synergists, for example melamine phosphate, melamine polyphosphate, melam, melem or melon, and melamine, melamine cyanurate or guanidine. The flame retardant mixtures may be used in polymer compositions in combination with fillers, for example with metal carbonates, MgO, hydrotalcites or Al₂O₃.

DE 10 2016 203 221 A1 discloses flame-retardant polyamide compositions comprising salts of dialkylphosphinic acid, telomers, organylphosphonate and phosphite, and additionally synergists, for example condensates of melamine, such as melam, melem or melon, or melamine cyanurate, melamine phosphates, melamine polyphosphates or aryl phosphates, or zinc stannate, zinc borate, MgO, magnesium carbonate, calcium carbonate, CaO, inter alia. The compositions may comprise fillers, for example magnesium carbonate, calcium carbonate, MgO or TiO2.

DE applications 10 2017 215775.5, 10 2017 215776.3, 10 2017 215777.1, 10 2017 215779.8 and 10 2017 215780.1, which were yet to be published at the priority date of the present application, disclose flame retardant mixtures comprising salts of dialkylphosphinic acid, telomers, organylphosphonate and phosphite, some of which may optionally also contain further components, for example melamine polyphosphate, melamine cyanurate and/or fillers.

In connection with cable insulation, indices such as good flame retardancy and good physical properties such as flexibility and tensile strength, and also processibility, abrasion resistance, oil resistance and esthetic problems are considered to be important. Particularly in the case of triazine complex-, polyphosphate- and hypophosphite-containing systems, little is known to the person skilled in the art with regard to stability to washout.

If just small amounts of a thermoplastic polymer ignite, the spreading flames can easily cause major damage. Therefore, halogen-containing flame retardants (FR) were commonly used in the past. In the event of fire, the thick plumes of smoke that arise therefrom can hinder orientation on the escape routes. Moreover, toxic vapors and corrosive combustion gases can arise, which are harmful to health and can be hazardous to the fabric of the building. The corrosivity of the halogens is also a problem during the recycling of waste materials.

The person skilled in the art is aware of different substance classes of flame retardants for polymers that can have advantages and disadvantages according to the field of use.

For instance, metal hydroxides as flame retardants frequently worsen the flexibility of polymers. Cables comprising magnesium hydroxide are frequently stiff and sensitive to scratching.

The use of nitrogen-containing compounds such as triazine complexes or nitrogen-containing diphosphates as flame retardants frequently has the effect of disadvantageous mold deposits. Some compositions containing a melamine cyanurate flame retardant fail the flammability test.

Aluminum hypophosphite as flame retardant is often required in large use amounts. However, this frequently reduces the stability of thermoplastic polyurethanes (“TPUs”).

TPUs are often inflammable. Halogenated flame retardants frequently show adverse effects on the mechanical values of TPUs.

Phosphates or polyphosphates are comparatively weak flame retardants and are unable to display their flame retardancy especially at relatively low temperatures.

Dialkylphosphinic acids and their salts, in combination with melamine polyphosphate, zinc oxide and glass fibers, often do not show an adequate effect, especially in polyolefins.

The breakdown of aluminum phosphite can generate toxic phosphine gas which can spontaneously ignite in the presence of air.

Phosphate and/or phosphonate materials frequently show only low flame retardancy. Flame retardancy tests are unstable, the oxygen index (“LOI”) is low, they migrate readily (and show a high tendency to elute), and can often be used only for low flame retardancy requirements.

Organophosphates and organophosphate esters are widely used since they result in relatively high flame retardancy. In general, however, these are liquids or low-melting solids that have high volatility or poor washout characteristics.

The addition of a large amount of flame retardants has the effect of bleeding (exudation) and deterioration of the mechanical properties of a plastic. It is therefore not easy to improve both flame retardancy and the mechanical properties of polymer moldings.

It is often the case that flame-retardant polymer formulations with P-N-unsaturated agents are problematic with regard to resistance (to washing out) by solvents. The flame retardants frequently bleed out of the polymer formulation or the molding manufactured therefrom.

In the case of use of polymer formulations, it has been found that flame retardants are frequently washed out in a moist, acidic or alkaline environment. This can lead to deterioration in flame retardancy on employment in polymer formulations, for example when the polymers are exposed to weathering.

The prior art discloses flame retardant compositions suitable for modification of polymer compositions that can be used as cable insulations inter alia.

For instance, DE 10 2015 004 661 A1 describes flame-retardant polyamide compositions comprising a combination of dialkylphosphinic salt, salt of phosphorous acid and phosphazene as flame retardant. DE 10 2016 203 221 A1 discloses flame-retardant polyamide compositions. These comprise a combination of dialkylphosphinic salt, a salt of phosphorous acid and condensation products of melamine as flame retardant.

The polyamide compositions described in the aforementioned documents have high thermal stability, have excellent glow wire flammability index (GWFI) demands of 960° C. and GWIT of 775° C., do not show any migration effects and have good flowability and high electrical values, expressed by a comparative tracking index (CTI) of greater than 550 V.

DE 10 2015 211 728 A1 discloses anticorrosive flame retardant formulations for thermoplastic polymers. These contain a combination of phosphinic salt, phosphazene and an inorganic zinc compound. The polymer compositions described show very good flame retardant efficacy and good mechanical properties of the compounds, and do not have elevated corrosion on processing. These flame retardants preferably also contain a nitrogen-containing synergist. In addition, the polymer compositions described are notable for very good electrical indices, such as tracking current resistance, and no corrosion is detectable in application tests.

EP 2 197 949 B1, corresponding to WO 2009/047353 A1, describes insulated cables for use in electronic devices that have an electrically conductive core and an insulation layer and/or an insulation sheath. The latter consist of a flame-retardant elastomeric composition encasing the electrically conductive core. This composition comprises a selected elastomeric polymer, a selected thermoplastic elastomer and, as flame retardant, a metal salt of a phosphinic acid and/or of a diphosphinic acid. In addition, it is possible to use a nitrogen-containing compound such as a condensation product of melamine and/or a selected inorganic compound such as a metal oxide, a metal hydroxide, a metal borate, a metal silicate or a metal stannate as flame retardant component. The cables described give a good balance between flame retardancy and mechanical and electrical properties, and are notable for softness, surface smoothness, low density and flexibility.

Flame-retardant polymer compositions that are particularly suitable for use as cable insulations are still in need of improvement in multiple respects.

It is an object of the present invention to provide flame-retardant polymer formulations that have very good flame retardancy and additionally have excellent stability to washout (elution) of the components of the flame retardant.

A further object is that of providing weather-resistant or leaching-resistant polymer compositions comprising thermoplastic elastomers, for example copolymer elastomers.

Yet a further object of the present invention is that of providing flame retardant mixtures by which advantageous stability to washout from the polymer can be achieved.

In addition, in the course of processing or use of the polymer compositions of the invention, no mold deposits, no reduced polymer stabilities and no reduced surface strengths are to occur. The flexibility of the polymer composition was also to be conserved.

Flame retardant mixtures have been found that surprisingly endow thermoplastic elastomer compositions with the profile of properties described above. It has been found that the flame retardant mixtures of the invention or the flame-retardant polymer formulations endowed therewith are superior to the pure phosphinic salt (without phosphite, alkylphosphonate, telomer), or to flame retardant mixtures of exactly that pure phosphinic salt with representatives from the group of triazine complex, polyphosphate, hypophosphite, nitrogen-containing diphosphate, organophosphate, phosphazene, polyphosphonate, intumescent additives, metal hydroxides, metal carbonates, metal borates, zinc stannates or the flame-retardant polymer formulations comprising pure phosphinic salt.

The prior art leads the person skilled in the art to expect considerable disadvantages in many respects when pure phosphinic salt alone or a flame retardant mixture of pure phosphinic salt with the above-described components is used in flame-retardant polymer formulations and/or in cables insulated with flame-retardant polymer formulation. In particular, disadvantages are expected in terms of stability to washout (elution) by water, acids or alkalis.

Contrary to expectation from the prior art, it has been found in accordance with the invention that selected combinations of flame retardants in polymer formulations comprising thermoplastic elastomers and optionally further polymers, elastomers and/or oils, such as polyphenylene oxide, polyolefins, naphtha oil, paraffin oil, EPDM, TPEE-styrene-rubber block copolymer blends or polyethylene, are particularly stable to washout.

The invention provides flame retardant mixtures comprising
a) 2-99.8% by weight of a salt of a phosphinic acid of the formula (I)

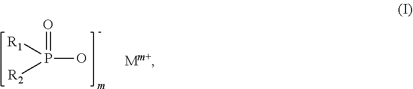

in which R₁ and R₂ are independently alkyl, cycloalkyl, aryl or aralkyl that are optionally substituted, preferably by alkyl radicals,
M is an m-valent cation, and
m is 1 to 4,
b) 0.005-10% by weight of the salt of a phosphinic acid of the formula (II) (also called “telomer” hereinafter) that differs from component a)

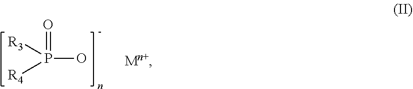

in which
R₃ is optionally substituted alkyl, cycloalkyl, cycloalkylalkyl, aryl or aralkyl, preferably with alkyl radicals as substituents,
R₄ is alkyl with an even number of carbon atoms, with the proviso that, if R₁ and/or R₂ are alkyl, R₄ has twice, three times or four times the number of carbon atoms of R₁ or R₂,
M is an n-valent cation, and
n is 1 to 4,
c) 0.005-10% by weight of organylphosphonate, preferably alkylphosphonate,
d) 0.005-20% by weight of phosphite,
e) 0-97.985% by weight of a representative selected from the group of triazine complex, polyphosphate, hypophosphite, nitrogen-containing diphosphate, organophosphate, phosphazene and/or polyphosphonate,
f) 0-97.985% by weight of a representative selected from the group of metal hydroxide, metal carbonate, metal borate, zinc stannate and/or intumescent additive, and
g) 0-30% by weight of pigment, where the percentages are based on the total mass of the flame retardant mixture and where at least one of components e) and f) must be present.

The proportion of component a) in the flame retardant mixture of the invention is typically 2% to 99.8% by weight, preferably 5% to 95% by weight and especially 75% to 95% by weight.

The proportion of component b) in the flame retardant mixture of the invention is typically 0.005% to 10% by weight and preferably 0.08% to 8% by weight.

The proportion of component c) in the flame retardant mixture of the invention is typically 0.005% to 10% by weight and preferably 0.08% to 8% by weight.

The proportion of component d) in the flame retardant mixture of the invention is typically 0.005% to 20% by weight and preferably 0.08% to 20% by weight.

The proportion of component e) in the flame retardant mixture of the invention is typically 0% to 97.985% by weight, preferably 0.5% to 95% by weight, more preferably 1% to 90% by weight, especially 1% to 40% by weight and most preferably 1% to 24% by weight.

The proportion of component f) in the flame retardant mixture of the invention is typically 0% to 97.985% by weight, preferably 1% to 95% by weight, and especially 1% to 40% by weight and most preferably 1% to 24% by weight.

The proportion of component g) in the flame retardant mixture of the invention is typically 0% to 30% by weight and preferably 0.3% to 10% by weight.

The above percentages are each based on the total mass of the flame retardant mixture.

The phosphinic salt of component a) is a compound of the above-described formula (I) where R₁, R₂, M and m have the definition given above.

If R₁ and/or R₂ are substituted, the substituents are one or more organic radicals, preferably one or two alkyl groups.

M is a mono- to tetravalent cation, especially a mono- to tetravalent metal cation, most preferably Al, Fe, TiOₚ or Zn.

m is an integer from 1 to 4, preferably from 2 to 3, and especially 2 or 3.

p is a number having the value of (4−m)/2.

R₁ and R₂ are preferably independently C₁-C₁₀-alkyl, C₅-C₆-cycloalkyl, alkyl-C₅-C₆-cycloalkyl, phenyl, alkylphenyl, phenylalkyl or alkylphenylalkyl, and more preferably are the same or different and are methyl, ethyl, n-propyl, isopropyl, n-butyl, sec-butyl, isobutyl, tert-butyl, n-pentyl, 2-pentyl, 3-pentyl, 2-methylbutyl, 3-methylbutyl (isopentyl), 3-methylbut-2-yl, 2-methylbut-2-yl, 2,2-dimethylpropyl (neopentyl), hexyl, heptyl, octyl, nonyl, decyl, cyclopentyl, cyclopentylethyl, cyclohexyl, cyclohexylethyl, phenyl, phenylethyl, methylphenyl and/or methylphenylethyl.

More preferably, R₁ and R₂ are independently C₁-C₆-alkyl or phenyl, and R₁ and R₂ are especially each ethyl.

Most preferred components a) are compounds of formula (I) in which R₁ and R₂ are each ethyl, m is 2 or 3 and M is Al, Fe or Zn.

The phosphinic salt of component b) is a compound of the above-described formula (II) where R₃, R₄, M and n have the definition given above.

If R₃ is substituted, the substituents are one or more organic radicals, preferably one or two alkyl groups.

M is a mono- to tetravalent cation, especially a mono- to tetravalent metal cation, most preferably Al, Fe, TiOₚ or Zn.

n is an integer from 1 to 4, preferably from 2 to 3, and especially 2 or 3.

p is a number having the value of (4−n)/2.

R₃ is preferably C₁-C₁₀-alkyl, C₅-C₆-cycloalkyl, alkyl-C₅-C₆-cycloalkyl, phenyl, alkylphenyl, phenylalkyl or alkylphenylalkyl, and more preferably is the same or different and is methyl, ethyl, n-propyl, isopropyl, n-butyl, sec-butyl, isobutyl, tert-butyl, n-pentyl, 2-pentyl, 3-pentyl, 2-methylbutyl, 3-methylbutyl (isopentyl), 3-methylbut-2-yl, 2-methylbut-2-yl, 2,2-dimethylpropyl (neopentyl), hexyl, heptyl, octyl, nonyl, decyl, cyclopentyl, cyclopentylethyl, cyclohexyl, cyclohexylethyl, phenyl, phenylethyl, methylphenyl and/or methylphenylethyl.

R₄ is an alkyl group having an even number of carbon atoms, preferably C₂-C₁₀-alkyl, more preferably ethyl, n-butyl, sec-butyl, isobutyl, tert-butyl, hexyl, octyl or decyl.

Particular preference is given to compounds of the formula (II) in which R₃ is C₁-C₆-alkyl or phenyl, especially ethyl, R₄ is ethyl, butyl, hexyl, octyl or decyl,

n is 2 or 3 and M is Al, Fe or Zn.

Particularly preferred compounds of the formula (II) (telomers) are selected from the group of the Mg, Ca, Al, Sb, Sn, Ge, Ti, Fe, Zr, Zn, Ce, Bi, Sr, Mn, Li, Na and/or K salts of ethylbutylphosphinic acid, dibutylphosphinic acid, ethylhexylphosphinic acid, butylhexylphosphinic acid, ethyloctylphosphinic acid, sec-butylethylphosphinic acid, 1-ethylbutylbutylphosphinic acid, ethyl-1-methylpentylphosphinic acid, di-sec-butylphosphinic acid (di-1-methylpropylphosphinic acid), propylhexylphosphinic acid, dihexylphosphinic acid, hexylnonylphosphinic acid, butyloctylphosphinic acid, hexyloctylphosphinic acid, dioctylphosphinic acid, ethylcyclopentylethylphosphinic acid, butylcyclopentylethylphosphinic acid, ethylcyclohexylethylphosphinic acid, butylcyclohexylethylphosphinic acid, ethylphenylethylphosphinic acid, butylphenylethylphosphinic acid, ethyl-4-methylphenylethylphosphinic acid, butyl-4-methylphenylethyl-phosphinic acid, butylcyclopentylphosphinic acid, butylcyclohexylethylphosphinic acid, butylphenylphosphinic acid, ethyl-4-methylphenylphosphinic acid or butyl-4-methylphenylphosphinic acid.

Very particularly preferred compounds of the formula (II) are selected from the group of the Al, Fe, TiOₚ and Zn salts of ethylbutylphosphinic acid, dibutylphosphinic acid, ethylhexylphosphinic acid, butylhexylphosphinic acid or dihexylphosphinic acid. Component c) is one or more organylphosphonate(s). These are salts of organylphosphonic acid, i.e. of phosphonic acid having a monovalent organic radical.

Typically, these are compounds of the formula (III)

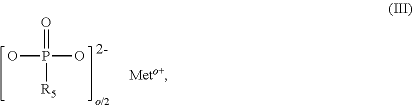

in which
R₅ is alkyl, cycloalkyl, aryl or aralkyl that is optionally substituted, preferably by alkyl radicals,
Met is an o-valent cation, and
is 1 to 4.

Met is a mono- to tetravalent cation, especially a mono- to tetravalent metal cation, most preferably Al, Fe, TiOₚ or Zn.

o is an integer from 1 to 4, preferably from 2 to 3, and especially 2 or 3.

p is a number having the value of (4−o)/2.

R₅ is preferably C₁-C₁₀-alkyl, C₅-C₆-cycloalkyl, alkyl-C₅-C₆-cycloalkyl, phenyl, alkylphenyl, phenylalkyl or alkylphenylalkyl, more preferably methyl, ethyl, n-propyl, isopropyl, n-butyl, sec-butyl, isobutyl, tert-butyl, n-pentyl, 2-pentyl, 3-pentyl, 2-methylbutyl, 3-methylbutyl (isopentyl), 3-methylbut-2-yl, 2-methylbut-2-yl, 2,2-dimethylpropyl (neopentyl), hexyl, heptyl, octyl, nonyl, decyl, cyclopentyl, cyclopentylethyl, cyclohexyl, cyclohexylethyl, phenyl, phenylethyl, methylphenyl and/or methylphenylethyl.

More preferably, R₅ is C₁-C₆-alkyl or phenyl, and R₅ is especially methyl or ethyl.

Most preferred components c) are compounds of formula (III) in which R₅ is methyl or ethyl, o is 2 or 3 and Met is Al, Fe or Zn.

Component d) is one or more phosphite(s). These are salts of inorganic phosphonic acid, i.e. of phosphonic acid having no organic radical, or an inorganic phosphonate.

These are typically compounds of the formula (IV) or (V)

[(HO)PO₂]²⁻_{q/2} Cat^{q+} (IV)

[(HO)₂PO]⁻_{q} Cat^{q+} (V)

in which Cat is a q-valent cation, especially a cation of an alkali metal or alkaline earth metal, an ammonium cation and/or a cation of Fe, Zn or especially of Al, including the cations Al(OH) or Al(OH)₂, and

q is 1, 2, 3 or 4.

Preferably, the inorganic phosphonate is aluminum phosphite [Al(H₂PO₃)₃], secondary aluminum phosphite [Al₂(HPO₃)₃], basic aluminum phosphite [Al(OH)(H₂PO₃)₂*2 aq], aluminum phosphite tetrahydrate [Al₂(HPO₃)₃*4 aq], aluminum phosphonate, Al₇(HPO₃)₉(OH)₆(1,6-hexanediamine)_{1.5}*12H₂O, Al₂(HPO₃)³*xAl₂O₃*nH₂O where x=2.27-1 and/or Al₄H₆P₁₆O₁₈.

The inorganic phosphonate of component d) preferably also comprises aluminum phosphites of the formulae (VI), (VII) and/or (VIII)

Al₂(HPO₃)₃x(H₂O)ᵣ (VI)

where r is 0 to 4,

Al_{2.00}M_{z}(HPO₃)_{y}(OH)ᵥx(H₂O)_{w} (VII)

where M denotes alkali metal cations, z is 0.01 to 1.5 and y is 2.63 to 3.5 and v is 0 to 2 and w is 0 to 4;

Al_{2.00}(HPO₃)ᵤ(H₂PO₃)ₜx(H₂O)ₛ (VIII)

where u is 2 to 2.99 and t is 2 to 0.01 and s is 0 to 4, and/or aluminum phosphite [Al(H₂PO₃)₃], secondary aluminum phosphite [Al₂(HPO₃)₃], basic aluminum phosphite [Al(OH)(H₂PO₃)₂*2 aq], aluminum phosphite tetrahydrate [Al₂(HPO₃)₃*4 aq], aluminum phosphonate, Al₇(HPO₃)₉(OH)₆(1,6-hexanediamine)_{1.5}*12H₂O, Al₂(HPO₃)³*xAl₂O₃*nH₂O where x=2.27-1 and/or Al₄H₆P₁₆O₁₈.

Particularly preferred inorganic phosphonates of component d) are aluminum, calcium and zinc salts.

Component e) comprises different substance classes of nitrogen- and/or phosphorus-containing compounds that are described in detail below. This component may be a triazine complex, polyphosphate, hypophosphite, nitrogen-containing diphosphate, organophosphate, phosphazene or polyphosphonate.

In the context of the present description, a triazine complex is understood to mean complexes of triazine derivatives, especially of cyanuric acid or isocyanuric acid, with nitrogen-containing compounds, such as with guanidine, melamine, urea, pyridine or guanidine carbonate.

The preferred triazine complexes include melamine cyanurate, urea cyanurate, pyridine-cyanuric acid complex (C₃N₃H₃O₃:C₅H₅N), guanidine carbonate-cyanuric acid complex, melamine isocyanurate and guanidine cyanurate.

These compounds are commercially available. For example, melamine cyanurate is commercially available under the Melapur MC 50 or Melapur MC XL name (from BASF) or Budit 315 (from Chem Fabrik Budenheim), Nordmin MC 25J (from NRC Nordmann&Rassmann) or Plastisan B3V (from Sigma).

Further triazine complex used with preference is PPM-triazine, e.g. poly[(6-(4-morpholinyl)-1,3,5-triazine-2,4-diyl)-1,4-piperazinediyl. PPM-triazine is understood to mean a compound of the formula —(C₃N₃X—Y—)ₛ— where X=morpholino, piperidino or a group derived from piperazine, Y is a group derived from piperazine, and s is an integer of not less than 3.

In the context of the present description, polyphosphates are understood to mean condensation products of salts of ortho-phosphoric acid having the general empirical formula M′ₜ₊₂PₜO₃ₜ₊₁ in which t is a number from 3 to 50 000 and M′ is a mono- to trivalent cation. Polyphosphates have the structure

M′-O—[P(OM′)(O)—O]ₜ-M′ in which t and M′ have the definitions described above. The polyphosphates of component e) also include compounds of triazine derivatives, preferably of melamine, with the above-described condensation products of ortho-phosphoric acid.

Preference is given to using, as component e), polyphosphate derivatives of melamine having a degree of condensation of not less than 20. The use of these compounds as flame retardant is known. For instance, DE 10 2005 016 195 A1 discloses a stabilized flame retardant comprising 99% to 1% by weight of melamine polyphosphate and 1% to 99% by weight of additive with reserve alkalinity. This document also discloses that this flame retardant can be combined with a phosphinic acid and/or a phosphinic salt.

Preferred flame retardant combinations of the invention comprise, as component e), a melamine polyphosphate having an average degree of condensation of 20 to 200, especially of 40 to 150.

Further preferred flame retardant combinations of the invention comprise, as component e) a melamine polyphosphate having a breakdown temperature of not less than 320° C., especially of not less than 360° C. and most preferably of not less than 400° C.

Preference is given to using, as component e), melamine polyphosphates that are known from WO 2006/027340 A1 (corresponding to EP 1 789 475 B1) and WO 2000/002869 A1 (corresponding to EP 1 095 030 B1).

Preference is given to using melamine polyphosphates having an average degree of condensation between 20 and 200, especially between 40 and 150, and having a melamine content of 1.1 to 2.0 mol, especially 1.2 to 1.8 mol, per mole of phosphorus atom.

Preference is likewise given to using melamine polyphosphates having an average degree of condensation (number-average) of >20, having a breakdown temperature of greater than 320° C., having a molar ratio of 1,3,5-triazine compound to phosphorus of less than 1.1, especially 0.8 to 1.0, and having a pH of a 10% slurry in water at 25° C. of 5 or higher, preferably 5.1 to 6.9.

Preference is given to using melamine polyphosphates having an average degree of condensation between 20 and 200, especially between 40 and 150, and having a melamine content of 1.1 to 2.0 mol, especially 1.2 to 1.8 mol, per mole of phosphorus atom.

Further preferred polyphosphate derivatives of component e) are ammonium polyphosphates of the formulae (NH₄)_{y}H_{3-y}PO₄ and (NH₄ PO₃)_{z}, with y=1 to 3 and z=1 to 10 000.

Hypophosphites in the context of the present description are preferably understood to mean salts of hypophosphorous acid H₄P₂O₆. In particular, metal salts are used.

Hypophosphorous acid metal salt (hypophosphite) used with preference as component e) conforms to the chemical formula (PH₂O₂)ᵤK in which u is an integer from 1 to 4 depending on the valency of the metal cation K.

K is preferably a cation of a metal of groups I, II, III and IV of the Periodic Table of the Elements. Preference is given to sodium, calcium, magnesium, zinc, tin and aluminum.

Components e) used with preference are calcium hypophosphite (Ca(H₂PO₂)₂) and aluminum hypophosphite (Al(H₂PO₂)₃).

The median particle size (d₅₀) of the hypophosphites used in accordance with the invention, especially of the aluminum phosphinate, is less than 40 μm, more preferably less than 15 μm.

In the context of the present description, nitrogen-containing diphosphates are understood to mean salts of diphosphates with nitrogen-containing organic compounds. The diphosphates (also called pyrophosphates) are condensates of two phosphates that are joined to one another via a P—O—P bond. Nitrogen-containing compounds used are especially nitrogen-containing heterocycles such as piperazine or melamine.

Nitrogen-containing diphosphates used with preference as component e) are (poly)piperazine pyrophosphate, melamine diphosphate (melamine pyrophosphate), for example a mixture of 40-80% (poly)piperazine pyrophosphate and 60-20% melamine diphosphate (melamine pyrophosphate).

In the context of the present description, organophosphates are understood to mean esters of orthophosphoric acid with alcohols or phenols.

Examples of organophosphates (organophosphate esters) used with preference as component e) are alkyl- and aryl-substituted phosphates and polymers thereof.

Examples of organophosphate esters are phosphate esters comprising phenyl groups, substituted phenyl groups or a combination of phenyl groups and substituted phenyl groups. Examples of these are phenyl bisdodecylphosphate, phenyl ethylhydrogenphosphate, phenyl bis(3,5,5-trimethylhexyl)phosphate, ethyl diphenylphosphate, 2-ethylhexyl di(tolyl)phosphate, diphenyl hydrogenphosphate, bis(2-ethylhexyl) p-tolylphosphate, tritolyl phosphate, bis(2-ethylhexyl) phenylphosphate, di(nonyl) phenylphosphate, phenyl methylhydrogenphosphate, di(dodecyl) p-tolylphosphate, p-tolyl bis(2,5,5-trimethylhexyl)phosphate or 2-ethylhexyl diphenylphosphate, bisphenol A bis(diphenylphosphate), tris(alkylphenyl) phosphate, resorcinol bis(diphenylphosphate), Fyroflex RDP and Fyroflex BDP, triphenyl phosphate, tris(isopropylphenyl) phosphate, t-butylphenyl diphenylphosphate, bis(t-butylphenyl) phenylphosphate, tris(t-butylphenyl)phosphate and/or tris(2-butoxyethyl) phosphate (TBEP).

Further examples of organic phosphate esters are aliphatic phosphate esters. These include trimethyl phosphate, tributyl phosphate, tri(2-ethylhexyl) phosphate, tributoxyethyl phosphate, monoisodecyl phosphate and acidic 2-acryloyloxyethyl phosphate.

Examples of aromatic phosphate esters include trixylenyl phosphate, tris(phenylphenyl) phosphate, trinaphthyl phosphate, cresyl diphenylphosphate, xylyl diphenylphosphate and diphenyl 2-methacryloyloxyethylphosphate.

Examples of aromatic bis(phosphate esters) include resorcinol bis(diphenylphosphate), resorcinol bis(dixylenylphosphate), resorcinol bis(dicresylphosphate), hydroquinone bis(dixylenylphosphate), bisphenol A bis(diphenylphosphate) and tetrakis(2,6-dimethylphenyl)-1,3-phenylene bisphosphate.

Very particularly suitable are resorcinol bis(diphenylphosphate) (RDP), bisphenol A bis(diphenylphosphate) and the ring-substituted derivatives thereof.

Phosphazenes are understood to mean chemical compounds having at least one P═N moiety.

Phosphazenes used with preference as component e) are phosphazene bisaryl esters, and among these more preferably the bis(phenoxy)phosphazenes. These may be oligomeric or polymeric, and cyclic or linear.

In one configuration, the bis(phenoxy)phosphazene is cyclic and has the structure

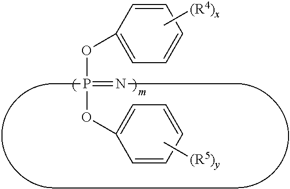

where
m is an integer from 3 to 25,
x and y are independently 0, 1, 2, 3, 4 or 5; and
R⁴ and R⁵ are C₁-C₁₂-alkyl or C₁-C₁₂-alkoxy.

In another configuration, the bis(phenoxy)phosphazene is linear and has the structure

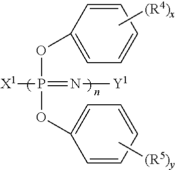

where
n is an integer from 3 to 10 000
X¹ represents a —N═P(OPh)₃ group or a —N═P(O)(OPh) group and Ph a phenyl group
Y¹ represents a —P(OPh)₄ group or a —P(O)(OPh)₂ group
x and y are independently 0, 1, 2, 3, 4 or 5, and
R⁴ and R⁵ are C₁-C₁₂-alkyl or C₁-C₁₂-alkoxy.

Preferred phosphazenes are type LY202 from Lanyin Chemical Co., Ltd., type FP-110 from Fushimi Pharmaceutical Co., Ltd. and type SPB-100 from Otsuka Chemical Co., Ltd.

In the context of the present description, polyphosphonates are understood to mean polymeric or oligomeric condensates of phosphonic acid.

Polyphosphonates used with preference as component e) are polymers or oligomers having units of the formula below

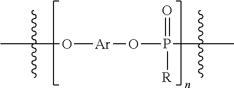

in which
Ar is an aromatic group
R is C₁₋₂₀-alkyl, C₂₋₂₀-alkenyl, C₂₋₂₀-alkynyl, C₅₋₂₀-cycloalkyl or C₆₋₂₀-aryl; and
n is an integer from 1 to 20.

In some embodiments, the —O—Ar—O— moiety may be derived from a compound selected from the group consisting of resorcinols, hydroquinones, bisphenols such as bisphenol A or bisphenol F, 4,4′-biphenol, phenolphthalein, 4,4′-thiodiphenol, 4,4′-sulfonyldiphenol, 1,1-bis(4-hydroxyphenyl)-3,3,5-trimethylcyclohexane and combinations thereof.

Component f) comprises different substance classes of compounds containing metal ions and oxygen that are described in detail below. This component may be metal hydroxide, metal carbonate, metal borate and/or zinc stannate.

In the context of the present description, metal hydroxides are understood to mean compounds containing hydroxide groups and metal ions.

Examples of metal hydroxides are hydroxides or basic oxides of metals, especially of metals of groups I, II, III and IV of the Periodic Table of the Elements. Preference is given to hydroxides of calcium, magnesium, zinc, tin and aluminum.

Components f) used with preference are magnesium hydroxide (Mg(OH)₂), aluminum hydroxide (ATH), boehmite and/or hydrotalcite.

Metal hydroxides used in accordance with the invention may also bring about or enhance a pigment effect. Such compounds can thus also be used as pigments.

In the context of the present description, metal carbonates are understood to mean compounds containing carbonate groups and metal ions.

Examples of metal carbonates are carbonates of metals, especially of metals of groups I, II, III and IV of the Periodic Table of the Elements. Preference is given to carbonates of calcium, magnesium or zinc.

Components f) used with preference are calcium carbonate, e.g. chalk or calcite, and magnesium carbonate or combinations thereof, such as dolomite.

In the context of the present description, metal borates are understood to mean metal salts of boric acid or hydrates thereof.

Examples of metal borates are boric acid salts of metals of groups I, II, III and IV of the Periodic Table of the Elements. Preference is given to borates containing calcium, magnesium or zinc.

Components f) used with preference are zinc borate and its hydrates, and the borates of the elements of the second main group of the Periodic Table.

In the context of the present description, metal stannates are understood to mean metal salts of stannic acid.

Examples of metal stannates are stannic acid salts of metals of groups I, II, III and IV of the Periodic Table of the Elements. Preference is given to stannates containing calcium, magnesium or zinc.

Components f) used with preference are aluminum hydroxide, calcium carbonate, tin borate and especially zinc stannate.

In the context of the present description, intumescent additives are understood to mean finely divided additives that are solid at 25° C. and increase in volume under the action of heat, optionally in combination with acid suppliers, form an insulating layer and hence prevent propagation and/or spread of the fire.

Examples of intumescent additives are expandable graphite, polyhydric alcohols, carbohydrates or phenol-formaldehyde resins.

Components f) used with preference are sorbitol, pentaerythritol, dipentaerythritol (from Perstorp) and epoxy novolak DEN438 with an epoxy equivalent weight of 176-(from Dow Chemical).

In the context of the present description, pigments are generally understood to mean additions that impart a desired color to the flame retardant mixture and a polymer composition comprising them. Pigments are understood to mean those substances that are in solid form when used in a polymer composition.

The pigments usable with preference include ZnO pigments and/or TiO₂ pigments.

The dyes and pigments usable with preference include carbon black, graphite, graphene, nigrosins, bone charcoal, black color pigments and combinations of complementary-colored red to yellow pigments with green, blue or violet pigments or mixtures of two or more of these compounds, e.g. Black CPH-294 (from Polymer Partner).

Preference is given to using red to yellow pigments with correspondingly complementary-colored green, blue or violet pigments or mixtures thereof in order to achieve a black color of the polymer composition.

Preferred pigments include copper phthalocyanine pigments having a green or blue color. The green color is generally achieved by substitution of hydrogen for chlorine atoms on the macrocyclic tetraamine.

Further suitable pigments are manganese violet pigments (pyrophosphates of ammonium and manganese(II) of the formula MnNH₄P₂O₇, which give bluer or redder hues through variation of the stoichiometric composition), ultramarine pigments (sodium and aluminum silicates), blue and green pigments based, for example, on chromium oxides or cobalt oxides having spinel structure. Pigments of this kind are commercially available under the Heliogen® blue, Heliogen® green, Sicopal® green, Sicopal® blue trade names (BASF SE brands), and as ultramarine, chromium oxide or manganese violet pigments.

Pigments of component g) that are used with preference are phthalocyanine blue, phthalocyanine green, Lisol red, permanent yellow or benzidine yellow.

Preferred pigments are, according to C. I. Part 1, Pigment blue 15, Pigment blue 15:2, Pigment blue 15:4, Pigment blue 16, Pigment blue 28, Pigment blue 29, Pigment blue 36, Pigment green 17, Pigment green 24, Pigment green 50, Pigment violet 15 and Pigment violet 16, particular preference being given to Pigment blue 15:1 and 15:3 and Pigment green 7 and 36.

The flame retardant mixtures of the invention comprise, as well as components a)-d), a representative of component e) and/or of component f).

The flame retardant mixtures of the invention comprise

2-99.8% by weight of component a),

0.005-10% by weight of component b),

0.005-10% by weight of component c),

0.005-20% by weight of component d),

0-97.985% by weight of component e),

0-97.985% by weight of component f), and

0-30% by weight of component g),

where at least one of components e) and f) must be present.

Particularly preferred flame retardant mixtures comprise

5-95% by weight of component a),

0.08-8% by weight of component b),

0.08-8% by weight of component c),

0.08-20% by weight of component d),

1-93% by weight of component e), and

0.3-10% by weight of component g).

Further particularly preferred flame retardant mixtures comprise

75-98.46% by weight of component a),

0.08-8% by weight of component b),

0.08-8% by weight of component c),

0.08-20% by weight of component d),

1-24% by weight of component f), and

0.3-10% by weight of component g).

Very particular preference is given to flame retardant mixtures comprising as component a) a compound of the above-defined formula (I) in which R₁ and R₂ are each ethyl and M is Fe, TiOₚ, Zn and especially Al, and as component b) a compound of the above-defined formula (II) which is selected from the group of the Fe, TiOₚ, Zn and especially the Al salts of ethylbutylphosphinic acid, dibutylphosphinic acid, ethylhexylphosphinic acid, butylhexylphosphinic acid or dihexylphosphinic acid.

The flame retardant mixtures of the invention may contain small amounts of halogen-containing components, for example up to 1% by weight of these components, based on the total mass of the flame retardant mixtures. More preferably, however, the flame retardant mixtures of the invention are halogen-free.

It has been found that, surprisingly, flame retardant mixtures comprising the above-defined components a) to d) and optionally at least one of components e) to g) used in thermoplastic elastomeric polymers, as well as excellent flame retardancy, lead to a low level of mold deposits and exhibit surprisingly high stability to washout.

The invention therefore also provides flame-retardant polymer compositions comprising, as well as a flame retardant mixture comprising the above-defined components a) to d) and optionally components e) and/or f) and/or g), additionally a thermoplastic elastomeric polymer as component h).

The thermoplastic and elastomeric polymers of component h) may be of a wide variety of different types. Such polymers are known to the person skilled in the art.

Examples of components h) are thermoplastic and elastomeric polyurethanes (TPE-U), thermoplastic and elastomeric polyesters (TPE-E), thermoplastic and elastomeric polyamides (TPE-A), thermoplastic and elastomeric polyolefins (TPE-O), thermoplastic and elastomeric styrene polymers (TPE-S) and thermoplastic silicone vulcanizates. It is also possible to use mixtures of thermoplastic and elastomeric polymers, for example blends of TPEE and styrene-butadiene block copolymer.

The thermoplastic and elastomeric polymers h) may have been formed from a wide variety of different monomer combinations. In general, these are blocks of what are called hard segments and soft segments. The soft segments in the case of the TPE-Us and the TPE-Es typically derive from polyalkylene glycol ethers, or in the case of the TPE-As from amino-terminated polyalkylene glycol ethers. The hard segments in the case of the TPE-Us, the TPE-As and the TPE-Es typically derive from short-chain diols or diamines. As well as the diols or diamines, the hard and soft segments are formed from aliphatic, cycloaliphatic and/or aromatic dicarboxylic acids or diisocyanates.

Examples of thermoplastic and elastomeric polyolefins are polymers containing units of ethylene-propylene-diene, especially ethylene-propylene-butadiene, and of polypropylene (EPDM/PP) or of nitrile-butadiene and of polypropylene (NBR/PP).

Examples of thermoplastic and elastomeric styrene polymers are polymers containing units of styrene-ethylene and of propylene-styrene (SEPS) or of of styrene-ethylene and of butadiene-styrene (SEBS) or of styrene and of butadiene (SBS).

Thermoplastic silicone vulcanizates derive from masses that contain poly(organo)siloxanes, for example poly(dimethyl)siloxanes, and are convertible to the elastomeric state. These polymers have groups amenable to crosslinking reactions, for example hydrogen atoms, hydroxyl groups or vinyl groups. According to the necessary crosslinking temperature, a distinction is made between cold-crosslinking (RTV) and hot-crosslinking (HTV) silicone rubbers. The crosslinking can be effected with addition of a suitable crosslinker by addition reactions or by condensation reactions. Frequently, peroxides are used as crosslinkers. Another crosslinking mechanism consists in an addition, usually catalyzed by precious metal compounds, of Si—H groups onto silicon-bonded vinyl groups.

In the context of this description, thermoplastic and elastomeric polymers are understood to mean polymers that have comparable behavior to the conventional elastomers at room temperature but can be plastically deformed with supply of heat and hence show thermoplastic characteristics. These thermoplastic and elastomeric polymers, in some regions, have physical crosslinking points (e.g. secondary valence forces or crystallites) that are dissolved on heating without breakdown of the polymer molecules.

The TPU base material used is a thermoplastic polyurethane, i.e. a material that can be processed by similar methods to thermoplastic polymer material, for example by extrusion or injection molding. TPU has polyurethane elastomer properties and can be repeatedly formed. It typically contains at least one polyester polyurethane from the group of polyether polyurethane, polycarbonate polyurethane or polycaprolactone polyurethane.

TPE-Es are also known as block copolymers, where the polyester segments in the hard blocks generally consist of repeat units of at least one alkylenediol and at least one aliphatic, cycloaliphatic or aromatic dicarboxylic acid. The soft blocks generally consist of segments of polyester, polycarbonate or polyether.

The TPE-Es used are preferably copolyetherester elastomers. The soft blocks in the case of these types are preferably derived from at least one polyalkylene oxide glycol. The aromatic dicarboxylic acids in the hard blocks of these preferred TPE-E types are preferably terephthalic acid, isophthalic acid, phthalic acid, naphthalene-2,6-dicarboxylic acid and/or 4,4-diphenyldicarboxylic acid. The alkylenediol in the hard blocks of these preferred TPE-E types is preferably ethylene glycol, propylene glycol, butylene glycol, hexane-1,2-diol, hexamethylene-1,6-diol, butane-1,4-diol, benzenedimethanol, cyclohexanediol and/or cyclohexanedimethanol.

Particular preference is given to using TPE-Es in which the hard blocks contain polybutylene terephthalate segments and/or polyethylene terephthalate segments.

The polyalkylene oxide glycol used in the TPE-E preferably derives from homo- or copolymers based on oxiranes, oxetanes and/or oxolanes. In particular, a poly(tetramethylene) glycol is used.

Polyalkylene oxide glycol copolymers may be random copolymers, block copolymers or mixed structures thereof, for example ethylene oxide/polypropylene oxide block copolymers, especially ethylene oxide-terminated polypropylene oxide glycol.

TPE-E used with preference contains hard blocks of polybutylene terephthalate and soft blocks of polytetramethylene glycol.

Examples of commercially available TPE-Es are Arnitel® from DSM, Kytrel® from DuPont or Riteflex® from Celanese.

TPE-As have polyamide segments in the hard blocks that preferably contain repeat units derived from at least one aromatic and/or aliphatic diamine and at least one aromatic or aliphatic dicarboxylic acid and/or an aliphatic aminocarboxylic acid. The soft segments preferably correspond to the polyalkylene oxides described for the TPE-Es, where these are terminated by amino groups on the end groups.

SEBS types used with preference are polystyrene-poly(ethylene-propylene) diblock copolymers obtainable, for example, as KRATON® from Kraton Performance Polymers. Further preferred SEBS types are polystyrene-poly(ethylene-butylene)-polystyrene triblock copolymers obtainable, for example, as KRATON® G. Further preferred SEBS types are polystyrene-poly(ethylene-ethylene/propylene)-polystyrene triblock copolymers obtainable, for example, as SEPTON® from Kuraray and as CALPRENE® H6140 from Dynasol. Further preferred SEBS types are polystyrene-poly(ethylene-propylene) diblock copolymers, polystyrene-poly(ethylene-butylene)-polyethylene triblock copolymers, polystyrene-poly(isoprene) diblock copolymers, polystyrene-poly(isoprene)-polystyrene triblock copolymers and polystyrene-polyethylene-polyisoprene-polystyrene terblock copolymers.

SEBS block copolymers used with preference have been partly or fully hydrogenated, have been maleic anhydride-grafted or epoxy-modified and/or are polystyrene triblock copolymers with a vinyl content, obtainable as KRATON® MD from Kraton.

Preference is given to using polymer blends containing not only SEBS but also PPO (polyphenylene oxide) and mineral oil. The SEBS component is preferably composed here of polystyrene, polypropylene and LPPE or LLDPE.

Polymer blends used with particular preference contain 18-42% by weight of SEBS, 12-30% by weight of mineral oil and 12-30% by weight of polyolefin.

Preference is given to using EPDM copolymers that derive from ethylene, propylene and one or more dienes. Preferred dienes are hexa-1,4-diene and monocyclic and polycyclic dienes. The molar ratios of ethylene to propylene are preferably from 95:5 to 5:95; the proportion of the diene units is preferably 0.1 to 10 mole percent.

An EPDM type used with particular preference is ethylene-propylene-diene rubber. Among those, particular preference is given to those types that derive from the dienes dicyclopentadiene, hexa-1,4-diene and/or ethylidenenorbornene.

Polymer blends used with preference contain TPE-Es and styrene-rubber copolymers. These especially include blends comprising polyester elastomer formed from a block copolymer composed of a hard polyester segment and soft segment derived from long-chain polyether glycols that has been mixed with styrene-rubber copolymer. Examples of useful styrene-rubber copolymers include a polystyrene block copolymer in which middle butadiene blocks have been hydrogenated, resulting in conversion of a styrene-butadiene-styrene (SBS) block terpolymer to a styrene-ethylene/butylene-styrene (SEBS) block terpolymer, and/or a polystyrene block copolymer containing styrene-derived polymer blocks and a further polymer block derived from a conjugated diene such as isoprene or butadiene.

Styrene-rubber block copolymers used with preference are styrene block copolymer (SBS) elastomers in which the styrene content in all blocks exceeds about 45% by weight, preferably about 55% by weight and more preferably about 65% by weight of the copolymer.

Polymer blends used with preference contain 58-83% by weight of TPE-E and 17-41% by weight of styrene-butadiene block copolymer or styrene triblock copolymer.

Further components h) used with preference are block copolymers containing rubber units of styrene/ethylene-butene copolymers, styrene/ethylene-propylene copolymers, styrene/ethylene-butene/styrene (SEBS) copolymers, styrene/ethylene-propylene/styrene (SEPS) copolymers, styrene-ethylene/butadiene (SEB) copolymers or styrene-butadiene-styrene (SBS) copolymers.

TPE-Os used with preference are block copolymers comprising a polyalkenylaromatic block and a polyolefin block. The polyolefin blocks here preferably consist of ethylene-octene copolymers, ethylene-butene copolymers, ethylene-propylene copolymers, polypropylenes, polybutenes or poly(ethylene-propylene) blocks. The polyalkylenearomatic block preferably consists of polystyrene. Examples of TPE-Os of this kind that are used with particular preference are polystyrene-poly(ethylene-butylene)-propylene-polystyrene block copolymers, polystyrene-poly(ethylene-butylene)-polystyrene triblock copolymers and mixtures thereof.

Thermoplastic silicone vulcanizates used with preference contain a matrix of a thermoplastic polymer and vulcanized silicone rubber particles. Particularly preferred thermoplastic silicone vulcanizates contain, as thermoplastic polymer, at least one representative from the group of polyolefin, polyamide, thermoplastic polyurethane or styrene block copolymer. Particularly preferred thermoplastic silicone vulcanizates contain, as vulcanized silicone particles, those that derive from diorganopolysiloxane having at least two silanol groups in the molecule and/or silicones and/or organohydridosilicon compounds having at least two silicon-bonded hydrogen groups in the molecule.

Thermoplastic silicone vulcanizate used with preference contains at least one thermoplastic polymer from the group of polyolefin and/or polybutylene terephthalate and at least one silicone vulcanizate derived from a diorganopolysiloxane having at least two alkenyl groups in the molecule and an organohydridosilicon compound having at least two silicon-bonded hydrogen groups in the molecule.

Thermoplastic silicone vulcanizates used with particular preference are, for example, the 3011 and/or 3111 types from Dow Corning.

Acrylonitrile-butadiene-styrene terpolymer (ABS) used with preference has a butadiene content of 18-20% by weight, an acrylonitrile content of 25-27% by weight and a styrene content of 53-57% by weight.

The polymer compositions of the invention may, in addition to component h), contain further polymers as component i).

These may be any thermoplastic polymers, for example polyolefins, polyarylene oxides, polyarylene sulfides, polyesters, polyamides or polyurethanes.

These may also be non-thermoplastic elastomers, for example block copolymers derived from rubber monomer units such as styrene-butadiene (SB), styrene-isoprene (SI), styrene-isoprene-styrene (SIS), α-methylstyrene-butadiene-α-methylstyrene and α-methylstyrene-isoprene-α-methylstyrene, or polybutene or polyisobutene (polyisobutylene).

Preferably, the polymer composition of the invention comprises, as a further component i), a polyolefin and/or a polyarylene oxide. Very particular preference is given to using blends comprising polyolefin and polyarylene oxide as component i).

Examples of polyolefins are homopolymers, such as polyethylene or polypropylene, e.g. high-density polyethylene (HDPE), medium-density polyethylene (MDPE) or low-density polyethylene (LDPE or LLDPE).

Further examples of polyolefins are olefin copolymers, for example those derived from ethylene and C₃-C₁₀ monoolefins, for example from propylene, 1-butene, 2-butene, 1-pentene, 2-pentene, 1-hexene, 2-hexene or 3-hexene. The molar ratios of ethylene to other C₃-C₁₀ monoolefin monomers are preferably from 95:5 to 5:95.

Olefin copolymers used with preference as component i) include linear low-density polyethylene (LLDPE).

Further polyolefin used with preference as component i) derives from 100-80% by weight of ethylene and from 0-20% by weight of one or more C4-8-α-olefin monomers (e.g. 1-butene, 1-hexene or 1-octene).

Examples of polyarylene oxides are polyphenylenephenylene oxides (PPOs).

The polymer compositions of the invention preferably contain, as component i), poly(arylene ethers). Especially those of the following of the formula:

—(C₆Z¹₂Z²₂—O)—

in which Z¹ and Z² are independently hydrogen, C₁-C₁₂-hydrocarbyl, C₁-C₁₂-hydrocarbylthio or C₁-C₁₂-hydrocarbyloxy.

Polyphenylene ethers used with preference contain 2,6-dimethyl-1,4-phenylene ether units, 2,3,6-trimethyl-1,4-phenylene ether units or a combination thereof. Particular preference is given to using a poly(2,6-dimethyl-1,4-phenylene ether).

Preferably, the poly(arylene ether) comprises aminoalkyl-containing end groups or tetramethyldiphenoquinone (TMDQ) end groups.

Polyarylene ethers may be present in the form of a homopolymer, a copolymer, a graft copolymer, an ionomer or a block copolymer, or else as combinations.

Preference is given to using poly(phenylene ether) homopolymers, as PPO® 640 and from SABIC and XYRON® S201A and S202A from Asahi Kasei Chemicals Corporation or as Blendex® HPP 820, from Chemtura.

Preferably, the polymer compositions of the invention comprise, as component i) blends of polyphenylene oxide and thermoplastic polymer, especially blends in which the thermoplastic polymer contains structural units derived from aromatic vinyl groups.

Preferred flame-retardant polymer compositions of the invention contain 25% to 57% by weight of poly(arylene ether) and 75% to 43% by weight of polyolefin, based on the total mass of poly(arylene ether) and polyolefin.

Preferably, the weight ratio of the poly(arylene ethers) to polyolefins is between 0.53:1 and 1.2:1.

In a further preferred embodiment, the thermoplastic and elastomeric polymer used as component h) contains 20% to 50% by weight of a poly(arylene ether) used as component i), more preferably 25% to 45% by weight and most preferably 30% to 45% by weight, where the percentages are based on the total mass of thermoplastic and elastomeric polymer and of poly(arylene ether).

The flame-retardant polymer compositions of the invention may also comprise further additives as component j). Preferred components j) in the context of the present invention are stabilizers such as oxidation retardants, thermal stabilizers, antioxidants, UV stabilizers, gamma ray stabilizers, hydrolysis stabilizers or costabilizers for antioxidants. Further examples of additives are antistats, emulsifiers, nucleating agents, plasticizers, lubricants, processing auxiliaries, impact modifiers, further flame retardants other than components a), b), c), d), e) and f), fillers and/or reinforcers.

The further additives are known per se as additions to flame-retardant polymer compositions and can be used alone or in a mixture or in the form of masterbatches.

A preferred plasticizer is mineral oil, e.g. naphtha oil, cycloalkyl white oil, aryl white oil, paraffin oil, paraffin white oil, white oil No. 26 and/or white oil No. 32. Preferred mineral oil is, for example, type KN4010 from Suzhou Hansen Special Oil Products.

Preferred stabilizers are sterically hindered phenols and/or phosphites, hydroquinones, aromatic secondary amines, such as diphenylamines, and mixtures thereof.

Preferred antioxidants are hindered phenols, phosphites, phosphonites, thio compounds such as thioesters, dilauryl thiodipropionate, dimyristyl thiodipropionate, distearyl thiodipropionate, siloxanes, polymerized 2,2,4-trimethyl-1,2-dihydroquinoline, N,N′-bis(1,4-dimethylpentyl-p-phenylenediamine), alkylated diphenylamines, mixed diaryl-p-phenylenediamines, metal deactivators (Irganox© 1024), vitamin E (alpha-tocopherol), lactones or hydroxylamine.

Preferred UV stabilizers are hindered amine light stabilizers (HALS) and UV light absorbers (UVA), for example of the TINUVIN® or SANDUVOR® type.

The lubricants include waxes. Among these, preference is given to waxes selected from the group of the polyolefin waxes, amide waxes, natural waxes, long-chain aliphatic carboxylic acids (fatty acids), or with polar modification by oxidation with air or with oxygenous gases or by grafting of, for example, unsaturated carboxylic acids, for instance maleic acid and/or esters or salts thereof or mixtures thereof.

Preferred polyolefin waxes are those that can be obtained by the polymerization of one or more α-olefins, especially with metallocene catalysts, PE waxes (polyethylene homo- and copolymer waxes), PTFE waxes, PP waxes (polypropylene homo- and copolymer waxes), FT paraffins, macro- and microcrystalline paraffins and polar polyolefin waxes (those preparable by oxidation of ethylene or propylene homopolymer and copolymer waxes or by grafting thereof with maleic anhydride), amide waxes preparable by reaction with ammonia or alkylenediamine, such as ethylenediamine or hexamethylenediamine, with saturated and/or unsaturated long-chain carboxylic acids having preferably 14 to 40 carbon atoms (more preferably having a carbon chain length of the carboxylic acid of 22 to 36 carbon atoms), for example stearic acid, tallow fatty acid, palmitic acid or erucic acid and/or natural waxes. Examples include carnauba wax or candelilla wax.

Preferred ester waxes are those with mono- or polyhydric alcohols having 2 to 6 carbon atoms, for example ethanediol, butane-1,4-diol, propane-1,2,3-triol, glycerol, trimethylolpropane, pentaerythritol or sorbitol.

Useful salts of the carboxylic acids mentioned are in particular alkali metal, alkaline earth metal, aluminum or zinc salts.

Fillers or reinforcers used may also be mixtures of two or more different fillers and/or reinforcers.

Preferred fillers are mineral particulate fillers based on quartz, titanium dioxide, amorphous silicas, nanoscale minerals, more preferably nanoboehmites, magnesium carbonate, chalk, feldspar, glass beads and/or barium sulfate.

Reinforcers used may, for example, be those based on carbon fibers and/or glass fibers.

In a preferred embodiment, filler and/or reinforcers may have been surface-modified, preferably with an adhesion promoter or an adhesion promoter system, more preferably a silane-based adhesion promoter system.

Preferred flame-retardant polymer compositions comprise

0.1-50% by weight, especially 0.1-50% by weight, of component a),

0.00001-5% by weight, especially 0.025-2.5% by weight, of component b),

0.00001-5% by weight, especially 0.025-2.5% by weight, of component c),

0.0001-12% by weight, especially 0.025-10% by weight, of component d),

0-50% by weight, especially 0-25% by weight and most preferably 0.5-25% by weight of component e),

0-50% by weight, especially 0-25% by weight and most preferably 0.5-25% by weight of component f),

0.1-15% by weight, especially 0.15-7.5% by weight, of component g), and

40-99% by weight of component h),

where at least one of components e) and f) must be present to an extent of at least

0.25% by weight and where the percentages are based on the total mass of the polymer composition.

Particularly preferred flame-retardant polymer compositions comprise

1-40% by weight of component a),

0.016-3% by weight of component b),

0.016-3% by weight of component c),

0.016-8% by weight of component d),

1-40% by weight of component e),

0.4-8% by weight of component g),

50-97% by weight of component h), and

0.5-20% by weight of polyphenylene oxide as component i),

where the percentages are based on the total mass of the polymer composition.

Further particularly preferred flame-retardant polymer compositions comprise

1-40% by weight of component a),

0.016-3% by weight of component b),

0.016-3% by weight of component c),

0.016-8% by weight of component d),

1-40% by weight of component f),

0.4-8% by weight of component g),

50-97% by weight of component h), and

0.5-20% by weight of polyphenylene oxide as component i),

where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

11-73% by weight of thermoplastic and elastomeric polyurethane as component h),

0-51% by weight, preferably 11-51% by weight, of polyolefin, especially of polypropylene, as component i) and/or

0-30% by weight of polyphenylene oxide as component i), where at least one of components e) and f) must be present to an extent of at least

0.25% by weight and where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

11-73% by weight of thermoplastic and elastomeric polyurethane as component h),

0-40% by weight, especially 1-40% by weight, of thermoplastic silicone vulcanizate as component h),

1-40% by weight of polyolefin, especially of polypropylene, as component i), and

0-30% by weight of polyphenylene oxide as component i), where at least one of components e) and f) must be present to an extent of at least

0.25% by weight and where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

7-42% by weight of SEBS as component h),

5-40% by weight of polyolefin, especially of polypropylene, as component i),

0-30% by weight, especially 0.1% to 30% by weight, of polyphenylene oxide as component i), and

5-30% by weight of mineral oil as component j), where at least one of components e) and f) must be present to an extent of at least

0.25% by weight and where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

7-42% by weight of SEBS as component h),

1-20% by weight of EPDM as component h),

5-40% by weight of polyolefin, especially of polypropylene, as component i),

0-30% by weight, especially 0.1% to 30% by weight, of polyphenylene oxide as component i), and

5-30% by weight of mineral oil as component j), where at least one of components e) and f) must be present to an extent of at least

0.25% by weight and where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

23-82% by weight of TPE-E as component h),

7-41% by weight of styrene-rubber block copolymer or styrene-rubber triblock copolymer as component h), and

0-30% by weight, especially 0.1% to 30% by weight, of polyphenylene oxide as component i),

where at least one of components e) and f) must be present to an extent of at least 0.25% by weight and where the percentages are based on the total mass of the polymer composition.

Particularly preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

8-57% by weight of TPE-E as component h),

3-42% by weight of SEBS as component h),

0-30% by weight, especially 0.1% to 30% by weight, of polyphenylene oxide as component i), and

2-30% by weight of mineral oil as component j), where at least one of components e) and f) must be present to an extent of at least

0.25% by weight and where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d),

0-50% by weight of component e),

0-50% by weight of component f),

0.1-15% by weight of component g),

8-57% by weight of TPE-O as component h),

3-42% by weight of SEBS as component h),

0-30% by weight, especially 0.1% to 30% by weight, of polyphenylene oxide as component i), and

2-30% by weight of mineral oil as component j), where at least one of components e) and f) must be present to an extent of at least

0.25% by weight and where the percentages are based on the total mass of the polymer composition.

Further preferred flame-retardant polymer compositions comprise

0.1-50% by weight of component a),

0.00001-5% by weight of component b),

0.00001-5% by weight of component c),

0.00001-12% by weight of component d), preferably of at least one representative from the group of triazine complex, MPP, hypophosphite, nitrogen-containing diphosphates, organophosphates or phosphazene,

0-50% by weight of component e), preferably of at least one representative from the group of metal hydroxides or metal carbonates,

0-50% by weight of component f),

0.1-15% by weight of component g),

6.4-78% by weight of TPE-E as component h),

6.4-25% by weight of polybutene as component i), and

1-40% by weight of polyphenylene oxide as component i), where at least one of components e) and f) must be present to an extent of at least

0.25% by weight and where the percentages are based on the total mass of the polymer composition.

Particularly preferred flame-retardant polymer compositions comprise

0.1-50% by weight of component a),

0.00001-5% by weight of component b),

0.00001-5% by weight of component c),

0.00001-12% by weight of component d),

0-50% by weight of component e), preferably of at least one representative from the group of triazine complex, MPP, hypophosphite, nitrogen-containing diphosphates, organophosphates or phosphazene,

0-50% by weight of component f), preferably of at least one representative from the group of metal hydroxides or metal carbonates, 0.1-15% by weight of component g),

6.4-55% by weight of TPE-E as component h),

8-78% by weight of SEBS as component h),

6.4-25% by weight of polybutene as component i), and

1-40% by weight of polyphenylene oxide as component i), where at least one of components e) and f) must be present to an extent of at least

0.25% by weight and where the percentages are based on the total mass of the polymer composition.

The aforementioned components a) to j) may be processed in a wide variety of different combinations to give the flame-retardant polymer composition of the invention. For instance, it is possible, right at the start or at the end of the polymerization or in a subsequent compounding operation, to mix the components into the polymer melt. In addition, there are processing operations in which individual components are not added until a later stage. This is practiced especially in the case of use of pigment or additive masterbatches. There is also the possibility of applying components, particularly those in pulverulent form, to the polymer pellets, which may be warm as a result of the drying operation, by drum application.

It is also possible to combine two or more of the components of the polymer compositions of the invention by mixing before they are introduced into the polymer matrix. It is possible here to use conventional mixing units in which the components are mixed in a suitable mixer, for example at 0 to 300° C. for 0.01 to 10 hours.

It is also possible to use two or more of the components of the polymer compositions of the invention to produce pellets that can then be introduced into the polymer matrix.

For this purpose, two or more components of the polymer composition of the invention can be processed with pelletizing aids and/or binders in a suitable mixer or a dish pelletizer to give pellets.

The crude product formed at first can be dried in a suitable drier or heat-treated to further increase the grain size.

The polymer composition of the invention or two or more components thereof may, in one embodiment, be produced by subjecting the ingredients to mixing, extruding, chopping (or optionally crushing and classifying) and drying (and optionally coating).

The polymer composition of the invention or two or more components thereof may, in one embodiment, be produced by spray granulation.

The flame-retardant polymer molding compound of the invention is preferably in pellet form, for example in the form of an extrudate or compound. The pelletized material is preferably in cylindrical form with a circular, elliptical or irregular footprint, in bead form, in cushion form, in cube form, in cuboid form or in prism form.

Typical length-to-diameter ratios of the pelletized material are 1:50 to 50:1, preferably 1:5 to 5:1.

The pelletized material preferably has a diameter of 0.5 to 15 mm, more preferably of to 3 mm, and preferably a length of 0.5 to 15 mm, more preferably of 2 to 5 mm.

The invention also provides moldings, especially cables or parts of cables, produced from the above-described flame-retardant polymer composition comprising the above-described components.

The moldings of the invention may be in any desired shape and form. Examples of these are cables, cable sheaths, cable insulations, fibers, films or shaped bodies obtainable from the flame-retardant polymer molding compounds of the invention by any desired shaping processes, especially by injection molding or extrusion.

The flame-retardant shaped polymer bodies of the invention can be produced by any desired shaping methods. Examples of these are injection molding, pressing, foam injection molding, internal gas pressure injection molding, blow molding, film casting, calendering, laminating or coating at relatively high temperatures with the flame-retardant polyamide molding compound.

The moldings are preferably injection moldings or extrudates.

The flame-retardant polymer compositions of the invention are suitable for production of fibers, films and shaped bodies, and especially of cables, cable sheaths or cable insulations.

The invention preferably relates to the use of the flame-retardant polymer compositions of the invention in or for plug connectors, current-bearing components in power distributors (residual current protection), circuit boards, potting compounds, plug connectors, circuit breakers, lamp housings, LED housings, capacitor housings, coil elements and ventilators, grounding contacts, plugs, in/on printed circuit boards, housings for plugs, flexible circuit boards, engine hoods or textile coatings, and especially for all kinds of cables, cable sheaths or cable insulations.

In particular, the polymer composition of the invention is used for production of cable sheaths.

The invention further relates to cables comprising:
A) one or more conduits, and
B) at least one layer comprising the flame-retardant polymer composition of the invention.

In a preferred embodiment, the invention relates to cables comprising:
i) one or more conduits, especially in the form of electrical or optical conduits, preferably in the form of a cord or a wire,
ii) at least one sheath of the conduit(s) with at least one polymeric layer,
iii) optionally at least one layer of separating agent on the sheath of the conduit(s),
iv) optionally at least one layer of shielding material, especially of metal braid or metal foil, surrounding the encased conduit(s),
v) optionally filling elements introduced between the conduits i), the one or more sheaths or layers ii), iii) or iv), and
vi) optionally an outer shell with at least one polymeric layer, with the proviso that at least one of the polymeric layers comprises the flame-retardant polymer composition of the invention.

Conduits used may be any individual conduits or combinations thereof in the form of cores, wires or cords.

Examples of conduits, such as for conduits for transfer of electrical or thermal energy, are metals, especially those comprising at least one representative from the group of silver, aluminum, copper, nickel, gold, zinc, tin or metal alloys, and electrical superconductors and/or ceramic high-temperature superconductors comprising, for example, YBa₂Cu₃O₇ (YBaCuO, YBCO), Bi₂Sr₂Ca₂Cu₃O₁₀, HgBa₂Ca₂Cu₃O₈ and/or Hg_{0.6}Tl_{0.2}Ba₂Ca₂Cu₃O_{8.33}.

Further examples of conduits, such as conduits for transfer of information, are conduits containing glass and/or polymers.

The conduits are encased individually or in groups by at least one polymeric layer comprising the polymer composition of the invention. This layer serves not only for electrical and thermal insulation of the conduits from the environment but also for flame retardancy. Insulation materials employed include different plastics that surround the conduits utilized as conductors and insulate them from one another. Considered in three dimensions, a cable has a usually cylindrical or similar geometry and may, in the overall structure, contain further shell layers of insulating material or metallic foils or braids for the purpose of electromagnetic shielding or of mechanical protection.

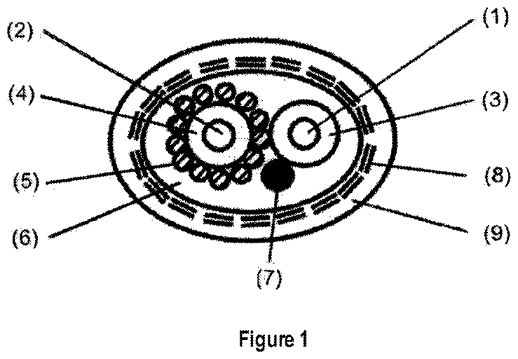

FIG. 1 describes, by way of example, a configuration of a cable of the invention. What are shown are conduits (1, 2) each ensheathed by a layer (3, 4) of the polymer composition of the invention. The ensheathed conduit (2) is additionally encased on the outer shell of the sheath (4) by a layer of separating agent (5). The combination of conduits (1, 3 and 2, 4, 5) is encased by a layer (6) of non-flame-retardant polymer composition. Within this casing, as well as the combination of conduits, there are also filler elements (7). On the outside of layer (6) is mounted a film screen (8), for example made of metal braid. One or more of these cable elements composed of the combination of conduits and the further elements (6, 7) are ultimately provided with an outer polymer shell (9). FIG. 1 elucidates an embodiment of a cable of the invention without limiting the invention thereto.

In a modification of the embodiment shown in FIG. 1, it is conceivable that the conduits (1, 2) are each ensheathed by a layer (3, 4) of a polymer composition, where said polymer composition is not a polymer composition of the invention. The ensheathed conduit (1) is additionally encased on the outer shell of the sheath (3) by a layer of separating agent (5). The combination of conduits (1, 3, 5 and 2, 4) is encased by a layer (6) of non-flame-retardant polymer composition. Within this casing, as well as the combination of conduits, there are also filler elements (7). On the outside of layer (6) is mounted a film screen (8), for example made of metal braid. One or more of these cable elements composed of the combination of conduits and the further elements (6, 7, 8) are ultimately provided with an outer polymer shell (9) of flame-retardant polymer composition of the invention.

In a further configuration of the cable of the invention, it is also conceivable that the conduits (1, 2) are each ensheathed by a layer (3, 4) of polymer composition, where just one of the layers (3, 4) the other of the layers (3, 4) does not contain a flame-retardant polymer composition of the invention.

The examples which follow elucidate the invention without restricting it.

Production of Compounds

The flame-retardant polymer compounds were produced in a Haake Polylab QC kneader from Thermo Scientific by kneading the amounts weighed out according to CORRECTED SHEET (RULE 91) ISA/EP the recipes in table 1 (for example 50 g in total) at 250° C. for 5 min, and cooling and grinding in a Retsch cutting mill.

These were used to press 12*12 cm plaques in a Dr. Collin P200T laboratory press.

Production, processing and testing of flame-retardant polymer compounds

The raw materials were mixed in the ratios specified in the tables and incorporated in via the side intake of a twin-screw extruder (Leistritz ZSE 27/44D) at temperatures of to 275° C. The homogenized polymer strand was drawn off, cooled in a water bath and then pelletized.

The dry pellets were used to produce a cable consisting of 3 copper cores, each of which had its own non-flame-retardant sheath, by extruding the flame-retardant polymer compound around the 3 braids. In accordance with the instructions from Underwriter Laboratories, the vertical wire flame test (VW-1) was conducted on the cables.

Determination of Degree of Elution

5 g of shredded starting compound were stirred with 34.8 g of 8% NaOH (solids concentration 13%) in a closed Schott glass bottle at room temperature for 8 h. Then the mixture was filtered through a black band filter paper and the filtrate was concentrated to about 6 g in a drying cabinet at 100° C. The filtrate was cooled and then filtered again. The filtercake of the compound after elution was dried in a drying cabinet at 100° C., then the P content thereof was determined.

$$Degree of elution [ \% ] = 100 - \frac{P content in compound after elution [ \% ] * 100}{P content in starting compound [ \% ]}$$

Raw Materials

Telomer used in accordance with the invention is aluminum ethylbutylphosphinate present in a proportion in a phosphinic acid salt, for example in the aluminum salt of diethylphosphinic acid prepared in analogy to example 1 of DE 10 2014 001 222 A1 (components a) and b)).

Alkylphosphonate used in accordance with the invention is aluminum ethylphosphonate prepared according to example 4 of U.S. Pat. No. 7,420,007 B2 (component c)).

Phosphite used in accordance with the invention is aluminum salt of phosphonic acid prepared according to example 1 of DE 10 2011 120 218 A1 (component d)).

Triazine complex used in accordance with the invention is melamine cyanurate from Shandong Shouguang Weidong Chemical Company (component e)).

Polyphosphate used in accordance with the invention is Budit 3141 from Budenheim (component e)).

Hypophosphite used in accordance with the invention is aluminum hypophosphite from Suzhou Antifire New Materials Co. (component e)).

Nitrogen-containing diphosphate used in accordance with the invention is a mixture of 60% piperazine pyrophosphate and 40% melamine pyro-/diphosphate (component e)).

Organophosphate used in accordance with the invention is Fyroflex RDP from ICL-IP (component e)).

Phosphazene used in accordance with the invention is Rabitle FP-110 from Fushimi (component e)).

Polyphosphonate used in accordance with the invention is Nofia HM 1100 from FRX Polymers (component e)).

Zinc borate used in accordance with the invention is Firebrake 500 from Rio Tinto (component f)).

Metal hydroxide used in accordance with the invention is aluminum hydroxide from Huber (component f)).

Metal carbonate used in accordance with the invention is calcite from Omnya (component f)).

PA66 used in the comparative examples is Ultramid A 27 E from BASF.

Glass fibers 1 used in the comparative examples are PPG 3610 from PPG.

PBT used in the comparative examples is Ultradur B4400 from BASF.

Glass fibers 2 used in the comparative examples are Vetrotex 995 from St. Gobain.

HTN used in the comparative examples is Zytel HTN 502 H NC10 from DuPont.

PPE used in accordance with the invention is PP0646 from Sabic (component i)).

SEBS used in accordance with the invention is Hytrel G1651 from DuPont (component h)).

TPE-E used in accordance with the invention is Hytrel G4074 from DuPont (component h)).

SEBS used in accordance with the invention is SEBS 6154 from Taiwan Rubber Co. (component h)).

Naphtha oil used in accordance with the invention is type KN4010 from Suzhou Hansen Special Oil Products (component j)).

PP used in accordance with the invention is type K7926 from Shanghai Secco Petrochemical (component i)).

TPU used in accordance with the invention is type Wantane WHT-8190 from Yantai Wanhua (component h)).

ABS used in accordance with the invention is Nancar 1965 from Nandi Chemical Industry Co. (component h)).

### EXAMPLES 1-3 (COMPARISONS)

According to the general methods, the raw materials from table 1 were used to knead compounds, press plaques and determine the degree of elution. The degree of elution for PA66, PBT and HTN was higher (i.e. the assessment was worse) than for the polymer compounds of the invention.

### EXAMPLES 4-22 (INVENTIVE)

According to general methods, with the figures from table 1, TPEE-styrene-butadiene block copolymer blend, phosphinic salt, telomer, phosphonate, phosphite, triazine complex, polyphosphate, nitrogen-containing diphosphate, hypophosphite, organophosphate, phosphazene, metal hydroxide, zinc borate, metal carbonate and pigments (Kronos 2230 titanium dioxide, White Seal zinc oxide from Bruggemann) were used to produce flame-retardant polymer compounds of the invention, plaques were pressed, the degree of elution thereof was determined, cables were produced and the fire protection classification was determined. The degree of elution was lower (i.e. the assessment was better) than in the comparative examples.

### EXAMPLES 23-30 (INVENTIVE)

According to general methods, with the figures from table 3, SEBS-PP-naphtha oil blend, PPE, phosphinic salt, telomer, phosphonate, phosphite, polyphosphate, metal hydroxide and the pigments used in examples 4-22 were used to produce flame-retardant polymer compounds of the invention, plaques were pressed, the degree of elution thereof was determined, cables were produced and the fire protection classification was determined. The degree of elution was lower (i.e. the assessment was better) than in the comparative examples.

### EXAMPLE 31 (INVENTIVE)

According to general methods, with the figures from table 3, SEBS-PP blend, phosphinic salt, telomer, phosphonate, phosphite, triazine complex, polyphosphate and the pigments used in examples 4-22 were used to produce flame-retardant polymer compounds of the invention, plaques were pressed, the degree of elution thereof was determined, cables were produced and the fire protection classification was determined. The degree of elution was lower (i.e. the assessment was better) than in the comparative examples.

### EXAMPLES 32-44 (INVENTIVE)

According to general methods, with the figures from table 4, a polyolefin-TPU blend, PPE, phosphinic salt, telomer, phosphonate, phosphite, triazine complex, polyphosphate, nitrogen-containing diphosphate, hypophosphite, polyphosphate, metal hydroxides, metal carbonate and the pigments used in examples 4-22 were used to produce flame-retardant polymer compounds of the invention, plaques were pressed, the degree of elution thereof was determined, cables were produced and the fire protection classification was determined. The degree of elution was lower (i.e. the assessment was better) than in the comparative examples.

### EXAMPLE 45 (INVENTIVE)

According to general methods, with the figures from table 4, TPU, PPE, phosphinic salt, telomer, phosphonate, phosphite, polyphosphate and the pigments used in examples 4-22 were used to produce flame-retardant polymer compounds of the invention, plaques were pressed, the degree of elution thereof was determined, cables were produced and the fire protection classification was determined. The degree of elution was lower (i.e. the assessment was better) than in the comparative examples.

### EXAMPLES 46-50 (INVENTIVE)

According to general methods, with the figures from table 5, a TPEE-PP-ABS blend, phosphinic salt, telomer, phosphonate, phosphite, triazine complex, polyphosphate and the pigments used in examples 4-22 were used to produce flame-retardant polymer compounds of the invention, plaques were pressed, the degree of elution thereof was determined, cables were produced and the fire protection classification was determined. The degree of elution was lower (i.e. the assessment was better) than in the comparative examples.

TABLE 1
Comparative examples

| | | | | Phos- | | | | | | | | | | | |
|---|---|---|---|---|---|---|---|---|---|---|---|---|---|---|---|
| | | | | phinic | Telo- | Phos- | Phos- | Triazine | Poly- | Zn | Glass | | VW-1 | | |
| | PA66 | PBT | HTN | salt | mers | phonate | phite | complex | phosphate | borate | fibers | TiO₂ | passed | Elution | |
| Ex. | [%] | [%] | [%] | [%] | [%] | [%] | [%] | [%] | [%] | [%] | [%] | [%] | [y/n] | [%] | Comments |
| V1 | 48.92 | — | — | 12.1 | 1.1 | 0.04 | 0.04 | — | 5.8 | 1 | 30 | 1 | N | 98 | glass fibers 1 |
| V2 | — | 48.94 | — | 12.9 | 0.3 | 0.03 | 0.03 | 6.8 | — | — | 30 | 1 | N | 95 | glass fibers 2 |
| V3 | — | — | 48.98 | 15.8 | 0.2 | 0.02 | 4 | — | — | — | 30 | 1 | N | 92 | glass fibers 1 |

TABLE 2
TPEE-styrene-butadiene block copolymer blends

| | | SB | | Phos- | | Phos- | | | Poly- | P—N- | | | | | | |
|---|---|---|---|---|---|---|---|---|---|---|---|---|---|---|---|---|
| | | block | | phinic | Telo- | pho- | Phos- | Triazine | phos- | unsat. | Zn | Me | | | VW-1 | |
| | TPEE | cop. | PPE | salt | mers | nate | phite | compl. | phate | agent | borate | carbonate | TiO₂ | ZnO | passed | Elution |
| Ex. | [%] | [%] | [%] | [%] | [%] | [%] | [%] | [%] | [%] | [%] | [%] | [%] | [%] | [%] | [y/n] | [%] |
| 4 | 47.96 | 35.3 | — | 6.8 | 0.6 | 0.02 | 0.02 | 7.2 | 1.1 | — | — | — | — | 1 | y | 28 |
| 5 | 48.08 | 35.3 | — | 7.2 | 0.1 | 0.01 | 0.01 | 7.2 | 1.1 | — | — | — | 1 | — | y | 23 |
| 6 | 48.05 | 35.3 | — | 7.3 | 0.04 | 0.005 | 0.005 | 7.7 | 1.1 | — | — | — | 0.5 | — | y | 23 |
| 7 | 48.06 | 35.3 | — | 6.8 | 0.1 | 0.4 | 0.04 | 6.7 | 1.1 | — | — | — | — | 1.5 | y | 21 |
| 8 | 47.99 | 35.3 | — | 5.8 | 0.1 | 0.01 | 1.5 | 6.7 | 1.1 | — | — | — | 1.5 | — | y | 24 |
| 9 | 48.00 | 35.3 | — | 13.9 | 1.2 | 0.05 | 0.05 | — | — | — | — | — | 1.5 | — | y | 28 |
| 10 | 68.96 | 14.3 | — | 6.8 | 0.6 | 0.02 | 0.02 | 7.2 | 1.1 | — | — | — | — | 1 | y | 26 |
| 11 | 61.96 | 9.3 | 10 | 6.8 | 0.6 | 0.02 | 0.02 | 6.2 | 3.1 | — | — | — | 2 | — | y | 29 |
| 12 | 62.08 | 9.3 | 10 | 7.2 | 0.1 | 0.01 | 0.01 | 7.2 | 3.1 | — | — | — | 1 | — | y | 22 |
| 13 | 62.05 | 9.3 | 10 | 7.3 | 0.04 | 0.005 | 0.005 | 7.7 | 3.1 | — | — | — | 0.5 | — | y | 22 |
| 14 | 62.06 | 9.3 | 10 | 6.8 | 0.1 | 0.4 | 0.04 | 6.7 | 3.1 | — | — | — | — | 1.5 | y | 24 |
| 15 | 61.99 | 9.3 | 10 | 5.8 | 0.1 | 0.01 | 1.5 | 6.7 | 3.1 | — | — | — | 1.5 | — | Y | 23 |
| 20 | 62.66 | 11.3 | 6 | 6.8 | 0.6 | 0.02 | 0.02 | — | 4.3 | 7.3 | — | — | — | 1 | y | 30 |
| 21 | 62.72 | 11.3 | 6 | 12.2 | 1.1 | 0.04 | 0.04 | — | 4.3 | — | 1.3 | — | 1 | — | y | 21 |
| 22 | 59.06 | 9 | 6 | 6.8 | 0.6 | 0.02 | 0.02 | — | 4.3 | — | — | 13.2 | — | 1 | y | 22 |

| | | SB | | Phos- | | Phos- | | | N-cont. | Hypo- | Organo | | | | | |
|---|---|---|---|---|---|---|---|---|---|---|---|---|---|---|---|---|
| | | block | | phinic | Telo- | pho- | Phos- | Triazine | diphos- | phos- | phos- | Me | | | VW-1 | |
| | TPEE | cop. | PPE | salt | mers | nate | phite | compl. | phate | phite | phate | hydroxide | TiO₂ | ZnO | passed | Elution |
| Ex. | [%] | [%] | [%] | [%] | [%] | [%] | [%] | [%] | [%] | [%] | [%] | [%] | [%] | [%] | [y/n] | [%] |
| 16 | 62.69 | 9.3 | 10 | 1.8 | 0.2 | 0.005 | 0.005 | — | 15 | — | — | — | — | 1 | y | 24 |
| 17 | 62.69 | 9.3 | 10 | 1.8 | 0.2 | 0.005 | 0.005 | — | — | 15 | — | — | 1 | — | y | 30 |
| 18 | 62.69 | 9.3 | 10 | 1.8 | 0.2 | 0.005 | 0.005 | — | — | — | — | 15 | — | 1 | y | 30 |
| 19 | 62.55 | 11.3 | 6 | 6.8 | 0.6 | 0.02 | 0.02 | 4.3 | — | — | 7.3 | — | 1 | — | y | 25 |

TABLE 3
SEBS-naphtha oil-PP blends

| | | | Poly- | | Phos- | | Phos- | | | Poly- | Hypo- | | | | | |
|---|---|---|---|---|---|---|---|---|---|---|---|---|---|---|---|---|
| | | Naphtha | pro- | | phinic | Telo- | pho- | Phos- | Triazine | phos- | phos- | Me | | | VW-1 | |
| | SEBS | oil | pylene | PPE | salt | mers | nate | phite | compl. | phate | phite | hydroxide | TiO₂ | ZnO | passed | Elution |
| Ex. | [%] | [%] | [%] | [%] | [%] | [%] | [%] | [%] | [%] | [%] | [%] | [%] | [%] | [%] | [y/n] | [%] |
| 23 | 32.04 | 22 | 22 | 9 | 8.2 | 0.7 | 0.03 | 0.03 | — | 4 | — | — | 2 | — | y | 25 |
| 24 | 23.48 | 16.2 | 16.2 | 5 | 6.7 | 0.7 | 0.02 | 4.4 | 26.3 | — | — | — | — | 1 | y | 25 |
| 25 | 31.96 | 22 | 22 | 9 | 8.8 | 0.2 | 0.02 | 0.02 | — | 5.5 | — | — | 0.5 | — | y | 30 |
| 26 | 32.03 | 22 | 22 | 9 | 8.9 | 0.05 | 0.01 | 0.01 | — | 5 | — | — | 1 | — | y | 22 |
| 27 | 31.95 | 22 | 22 | 9 | 8.3 | 0.2 | 0.5 | 0.05 | — | 4.5 | — | — | — | 1.5 | y | 28 |
| 28 | 31.99 | 22 | 22 | 9 | 7.1 | 0.1 | 0.01 | 1.8 | — | 4.5 | — | — | 1.5 | — | y | 24 |
| 29 | 32.08 | 22 | 22 | 9 | 2.7 | 0.2 | 0.01 | 0.01 | — | — | 11 | — | — | 1 | y | 29 |
| 30 | 32.08 | 22 | 22 | 9 | 2.7 | 0.2 | 0.01 | 0.01 | — | — | — | 11 | — | 1 | y | 30 |
| 31 | 46.06 | — | 5 | — | 21.0 | 1.8 | 0.07 | 0.07 | 15 | 10 | — | — | 1 | — | y | 24 |

TABLE 4
TPU-PP blends

| | Poly- | | | Phos- | | Phos- | | | Poly- | N-cont. | Hypo- | Poly- | | | | |
|---|---|---|---|---|---|---|---|---|---|---|---|---|---|---|---|---|
| | pro- | | | phinic | Telo- | pho- | Phos- | Triazine | phos- | diphos- | phos- | phos- | | | VW-1 | |
| | pylene | TPU | PPE | salt | mers | nate | phite | compl. | phate | phate | phite | phonate | TiO₂ | ZnO | passed | Elution |
| Ex. | [%] | [%] | [%] | [%] | [%] | [%] | [%] | [%] | [%] | [%] | [%] | [%] | [%] | [%] | [y/n] | [%] |
| 32 | 50.96 | 11 | — | 20.1 | 1.8 | 0.07 | 0.07 | 10 | 5 | — | — | — | 1 | — | y | 28 |
| 33 | 11 | 51.02 | — | 20.1 | 1.8 | 0.07 | 0.01 | 4 | 10 | — | — | — | 2 | — | y | 28 |
| 34 | 11 | 51.02 | — | 21.5 | 0.4 | 0.04 | 0.04 | 5 | 10 | — | — | — | 1 | — | y | 27 |
| 35 | 11 | 51.06 | — | 21.8 | 0.1 | 0.02 | 0.02 | 5.5 | 10 | — | — | — | 0.5 | — | y | 27 |
| 36 | 11 | 51.00 | — | 20.4 | 0.4 | 1.1 | 0.1 | 4.5 | 10 | — | — | — | — | 1.5 | y | 25 |
| 37 | 11 | 50.98 | — | 17.4 | 0.2 | 0.02 | 4.4 | 4.5 | 10 | — | — | — | 1.5 | — | y | 23 |
| 38 | 30.5 | 30.46 | — | 4.6 | 0.4 | 0.02 | 0.02 | 23 | 10 | — | — | — | 1 | — | y | 21 |
| 39 | 11 | 50.99 | 9 | 0.9 | 0.1 | 0.003 | 0.005 | — | — | 27 | — | — | 1 | — | y | 22 |

| | Poly- | | | Phos- | | Phos- | | | Hypo- | Poly- | | | | | | |
|---|---|---|---|---|---|---|---|---|---|---|---|---|---|---|---|---|
| | pro- | | | phinic | Telo- | pho- | Phos- | Triazine | phos- | phos- | Metal | Metal | | | VW-1 | |
| | pylene | TPU | PPE | salt | mers | nate | phite | compl. | phite | phonate | hydroxide | carbonate | TiO₂ | ZnO | passed | Elution |
| Ex. | [%] | [%] | [%] | [%] | [%] | [%] | [%] | [%] | [%] | [%] | [%] | [%] | [%] | [%] | [y/n] | [%] |
| 40 | 11 | 50.98 | 9 | 1.8 | 0.2 | 0.01 | 0.01 | 10 | 16 | — | — | — | 1 | — | y | 21 |
| 41 | 11 | 50.94 | 9 | 9.8 | 0.9 | 0.03 | 0.03 | 10 | — | 7.3 | — | — | 1 | — | y | 26 |
| 42 | 11 | 50.98 | 9 | 1.8 | 0.2 | 0.01 | 0.01 | 10 | — | — | 16 | — | — | 1 | y | 21 |
| 43 | 11 | 51.00 | 9 | 16.5 | 1.4 | 0.05 | 0.05 | — | 10 | — | — | — | 1 | — | y | 22 |
| 44 | 11 | 50.98 | 9 | 1.8 | 0.2 | 0.01 | 0.01 | — | — | — | — | 26 | — | 1 | y | 30 |
| 45 | — | 72.56 | 4 | 6.8 | 0.6 | 0.02 | 0.02 | 8 | 7 | — | — | — | 1 | — | y | 29 |

TABLE 5
TPEE-ABS-PP blends

| | | Poly- | | Phos- | | | | Poly- | | | | |
|---|---|---|---|---|---|---|---|---|---|---|---|---|
| | | pro- | | phinic | Telo- | Phos- | Phos- | phos- | | | VW-1 | |
| | TPE-E | pylene | ABS | salt | mers | phonate | phite | phonate | TiO₂ | ZnO | passed | Elution |
| Ex. | [%] | [%] | [%] | [%] | [%] | [%] | [%] | [%] | [%] | [%] | [y/n] | [%] |
| 46 | 30 | 8 | 34.98 | 18.3 | 1.6 | 0.06 | 0.06 | 5 | 2 | — | y | 28 |
| 47 | 30 | 8 | 35.02 | 19.5 | 0.4 | 0.04 | 0.04 | 6 | 1 | — | y | 22 |
| 48 | 30 | 8 | 34.96 | 19.9 | 0.1 | 0.02 | 0.02 | 6.5 | 0.5 | — | y | 23 |
| 49 | 30 | 8 | 35.00 | 18.5 | 0.4 | 1.0 | 0.1 | 5.5 | — | 1.5 | y | 30 |
| 50 | 30 | 8 | 34.98 | 15.8 | 0.2 | 0.02 | 4 | 5.5 | 1.5 | — | y | 21 |

1. A flame retardant mixture comprising
a) 2-99.8% by weight of the salt of a phosphinic acid of the formula (I) 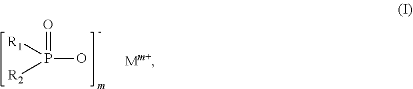
in which
R₁ and R₂ are independently alkyl, cycloalkyl, aryl or aralkyl that are optionally substituted,
M is an m-valent cation, and
m is 1 to 4,
b) 0.005-10% by weight of the salt of a phosphinic acid of the formula (II) that differs from component a) 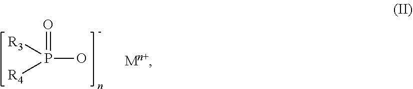
in which
R₃ is optionally substituted alkyl, cycloalkyl, cycloalkylalkyl, aryl or aralkyl, preferably with alkyl radicals as substituents,
R₄ is alkyl with an even number of carbon atoms, with the proviso that, if R₁ and/or R₂ are alkyl, R₄ has twice, three times or four times the number of carbon atoms of R₁ or R₂,
M is an n-valent cation, and
n is 1 to 4,
c) 0.005-10% by weight of organylphosphonate,
d) 0.005-20% by weight of phosphite,
e) 0-97.985% by weight of a representative selected from the group of triazine complex, polyphosphate, hypophosphite, nitrogen-containing diphosphate, organophosphate, phosphazene and/or polyphosphonate,
f) 0-97.985% by weight of a representative selected from the group of metal hydroxide, metal carbonate, metal borate, zinc stannate and/or intumescent additive, and
g) 0-30% by weight of pigment,
where the percentages are based on the total mass of the flame retardant mixture and where at least one of components e) and f) must be present.

2. The flame retardant mixture as claimed in claim 1, which comprises, as well as components a) to d), a representative of components e) and f).

3. The flame retardant mixture as claimed in claim 1, wherein M is a mono- to tetravalent metal cation, most preferably Al, Fe, TiOₚ or Zn, in which p is a number having the value of (4−m)/2 or having the value of (4−n)/2.

4. The flame retardant mixture as claimed in claim 1, wherein R₁ and R₂ are independently C₁-C₆-alkyl or phenyl, and are especially each ethyl.

5. The flame retardant mixture as claimed in claim 1, wherein R₃ is C₁-C₆-alkyl or phenyl, especially ethyl, R₄ is ethyl, butyl, hexyl, octyl or decyl, n is 2 or 3 and M is Al, Fe or Zn.

6. The flame retardant mixture as claimed in claim 1, wherein component c) is a compound of the formula (III) 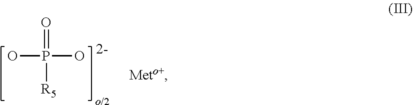
in which
R₅ is alkyl, cycloalkyl, aryl or aralkyl that is optionally substituted,
Met is an o-valent cation, and
o is 1 to 4.

7. The flame retardant mixture as claimed in claim 6, wherein R₅ is methyl or ethyl, o is 2 or 3 and Met is Al, Fe or Zn.

8. The flame retardant mixture as claimed in claim 1, wherein component d) is a compound of the formula (IV) or (V)
[(HO)PO₂]²⁻_{q/2} Cat^{q+} (IV)
[(HO)₂PO]⁻_{q} Cat^{q+} (V)
in which
Cat is a q-valent cation, especially a cation of an alkali metal or alkaline earth metal, an ammonium cation and/or a cation of Fe, Zn or especially of Al, including the cations Al(OH) or Al(OH)₂, and q is 1, 2, 3 or 4.

9. The flame retardant mixture as claimed in claim 1, wherein component e) is a melamine polyphosphate having a decomposition temperature of not less than 320° C., especially of not less than 360° C. and most preferably of not less than 400° C.

10. The flame retardant mixture as claimed in claim 1, wherein component f) is aluminum hydroxide, calcium carbonate, zinc borate and/or zinc stannate.

11. The flame retardant mixture as claimed in claim 1, which comprises
5-95% by weight of component a),
0.08-8% by weight of component b),
0.08-8% by weight of component c),
0.08-20% by weight of component d),
1-93% by weight of component e), and/or
0.3-10% by weight of component g).

12. The flame retardant mixture as claimed in claim 11, which comprises
75-98.46% by weight of component a),
0.08-8% by weight of component b),
0.08-8% by weight of component c),
0.08-20% by weight of component d),
1-24% by weight of component f), and/or
0.3-10% by weight of component g).

13. The flame retardant mixture as claimed in claim 1, which comprises, as component a), a compound of the formula (I) in which R₁ and R₂ are each ethyl and M is Al, and, as component b), a compound of the formula (II) selected from the group of the Al salts of ethylbutylphosphinic acid, dibutylphosphinic acid, ethylhexylphosphinic acid, butylhexylphosphinic acid or dihexylphosphinic acid.

14. A flame-retardant polymer composition comprising
a) salt of a phosphinic acid of the formula (I) 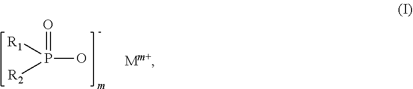
in which
R₁ and R₂ are independently alkyl, cycloalkyl, aryl or aralkyl that are optionally substituted,
M is an m-valent cation, and
m is 1 to 4,
b) salt of a phosphinic acid of the formula (II) that differs from component a) 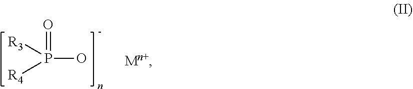
in which
R₃ is optionally substituted alkyl, cycloalkyl, cycloalkylalkyl, aryl or aralkyl, preferably with alkyl radicals as substituents,
R₄ is alkyl with an even number of carbon atoms, with the proviso that, if R₁ and/or R₂ are alkyl, R₄ has twice, three times or four times the number of carbon atoms of R₁ or R₂,
M is an n-valent cation, and
n is 1 to 4,
c) organylphosphonate,
d) phosphite,
e) optionally a representative selected from the group of triazine complex, polyphosphate, hypophosphite, nitrogen-containing diphosphate, organophosphate, phosphazene and/or polyphosphonate,
f) optionally a representative selected from the group of metal hydroxide, metal carbonate, metal borate, zinc stannate and/or intumescent additive,
g) optionally pigment, and
h) at least one thermoplastic elastomeric polymer.

15. The flame-retardant polymer composition as claimed in claim 14, wherein component h) is selected from the group of the thermoplastic and elastomeric polyurethanes (TPE-U), thermoplastic and elastomeric polyesters (TPE-E), thermoplastic and elastomeric polyamides (TPE-A), thermoplastic and elastomeric polyolefins (TPE-O), thermoplastic and elastomeric styrene polymers (TPE-S), thermoplastic silicone vulcanizates or the mixtures of two or more of these thermoplastic and elastomeric polymers.

16. The flame-retardant polymer composition as claimed in claim 14, which comprises, as component i), polyphenylene oxide and/or polyolefin.

17. The flame-retardant polymer composition as claimed in claim 14, which comprises, as component j), further additives, especially stabilizers, antistats, emulsifiers, nucleating agents, plasticizers, lubricants, processing auxiliaries, impact modifiers, further flame retardants other than components a), b), c), d), e) and f), fillers and/or reinforcers.

18. The flame-retardant polymer composition as claimed in claim 14, which comprises
0.1-50% by weight of component a),
0.00001-5% by weight of component b),
0.00001-5% by weight of component c),
0.0001-12% by weight of component d),
0-50% by weight of component e),
0-50% by weight of component f),
0.1-15% by weight of component g), and
40-99% by weight of component h),
where at least one of components e) and f) must be present to an extent of at least 0.25% by weight and where the percentages are based on the total mass of the polymer composition.

19. The flame-retardant polymer composition as claimed in claim 18, which comprises
0.1-50% by weight of component a),
0.025-2.5% by weight of component b),
0.025-2.5% by weight of component c),
0.025-10% by weight of component d),
0.5-25% by weight of component e),
0-25% by weight of component f),
0.15-7.5% by weight of component g), and
40-99% by weight of component h).

20. The flame-retardant polymer composition as claimed in claim 18, which comprises
0.1-50% by weight of component a),
0.025-2.5% by weight of component b),
0.025-2.5% by weight of component c),
0.025-10% by weight of component d),
0-25% by weight of component e),
0.5-25% by weight of component f),
0.15-7.5% by weight of component g), and
40-99% by weight of component h).

21. The flame-retardant polymer composition as claimed in claim 14, which comprises
1-40% by weight of component a),
0.016-3% by weight of component b),
0.016-3% by weight of component c),
0.016-8% by weight of component d),
1-40% by weight of component e),
0.4-8% by weight of component g),
50-97% by weight of component h), and
0.5-20% by weight of polyphenylene oxide as component i),
where the percentages are based on the total mass of the polymer composition.

22. The flame-retardant polymer composition as claimed in claim 14, which comprises
1-40% by weight of component a),
0.016-3% by weight of component b),
0.016-3% by weight of component c),
0.016-8% by weight of component d),
1-40% by weight of component f),
0.4-8% by weight of component g),
50-97% by weight of component h), and
0.5-20% by weight of polyphenylene oxide as component i),
where the percentages are based on the total mass of the polymer composition.

23. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
11-73% by weight of thermoplastic and elastomeric polyurethane as component h),
0-51% by weight, preferably 11-51% by weight, of polyolefin as component i) and/or
0-30% by weight of polyphenylene oxide as component i),
where at least one of components e) and f) must be present to an extent of at least 0.25% by weight and where the percentages are based on the total mass of the polymer composition.

24. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
11-73% by weight of thermoplastic and elastomeric polyurethane as component h),
0-40% by weight of thermoplastic silicone vulcanizate as component h),
1-40% by weight of polyolefin as component i), and
0-30% by weight of polyphenylene oxide as component i),
where at least one of components e) and f) must be present to an extent of at least 0.25% by weight and where the percentages are based on the total mass of the polymer composition.

25. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
7-42% by weight of SEBS as component h),
5-40% by weight of polyolefin as component i),
0-30% by weight, especially 0.1% to 30% by weight, of polyphenylene oxide as component i), and
5-30% by weight of mineral oil as component j),
where at least one of components e) and f) must be present to an extent of at least 0.25% by weight and where the percentages are based on the total mass of the polymer composition.

26. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
7-42% by weight of SEBS as component h),
1-20% by weight of EPDM as component h),
5-40% by weight of polyolefin as component i),
0-30% by weight, especially 0.1% to 30% by weight, of polyphenylene oxide as component i), and
5-30% by weight of mineral oil as component j),
where at least one of components e) and f) must be present to an extent of at least 0.25% by weight and where the percentages are based on the total mass of the polymer composition.

27. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
23-82% by weight of TPE-E as component h),
7-41% by weight of styrene-rubber block copolymer or styrene-rubber triblock copolymer as component h), and
0-30% by weight, especially 0.1% to 30% by weight, of polyphenylene oxide as component i),
where at least one of components e) and f) must be present to an extent of at least 0.25% by weight and where the percentages are based on the total mass of the polymer composition.

28. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
8-57% by weight of TPE-E as component h),
3-42% by weight of SEBS as component h),
0-30% by weight, especially 0.1% to 30% by weight, of polyphenylene oxide as component i), and
2-30% by weight of mineral oil as component j),
where at least one of components e) and f) must be present to an extent of at least 0.25% by weight and where the percentages are based on the total mass of the polymer composition.

29. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e),
0-50% by weight of component f),
0.1-15% by weight of component g),
8-57% by weight of TPE-O as component h),
3-42% by weight of SEBS as component h),
0-30% by weight, especially 0.1% to 30% by weight, of polyphenylene oxide as component i), and
2-30% by weight of mineral oil as component j),
where at least one of components e) and f) must be present to an extent of at least 0.25% by weight and where the percentages are based on the total mass of the polymer composition.

30. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e), preferably of at least one representative from the group of triazine complex, MPP, hypophosphite, nitrogen-containing diphosphates, organophosphates or phosphazene,
0-50% by weight of component f), preferably of at least one representative from the group of metal hydroxides or metal carbonates,
0.1-15% by weight of component g),
6.4-78% by weight of TPE-E as component h),
6.4-25% by weight of polybutene as component i), and
1-40% by weight of polyphenylene oxide as component i),
where at least one of components e) and f) must be present to an extent of at least 0.25% by weight and where the percentages are based on the total mass of the polymer composition.

31. The flame-retardant polymer composition as claimed in claim 14, which comprises
0.1-50% by weight of component a),
0.00001-5% by weight of component b),
0.00001-5% by weight of component c),
0.00001-12% by weight of component d),
0-50% by weight of component e), preferably of at least one representative from the group of triazine complex, MPP, hypophosphite, nitrogen-containing diphosphates, organophosphates or phosphazene,
0-50% by weight of component f), preferably of at least one representative from the group of metal hydroxides or metal carbonates,
0.1-15% by weight of component g),
6.4-55% by weight of TPE-E as component h),
8-78% by weight of SEBS as component h),
6.4-25% by weight of polybutene as component i), and
1-40% by weight of polyphenylene oxide as component i),
where at least one of components e) and f) must be present to an extent of at least 0.25% by weight and where the percentages are based on the total mass of the polymer composition.

32. A molding produced from a flame-retardant polymer composition as claimed in claim 14.

33. The use of the flame-retardant polymer composition as claimed in claim 14 in or for plug connectors, current-bearing components in power distributors (residual current protection), circuit boards, potting compounds, plug connectors, circuit breakers, lamp housings, LED housings, capacitor housings, coil elements and ventilators, grounding contacts, plugs, in/on printed circuit boards, housings for plugs, flexible circuit boards, engine hoods or textile coatings, and especially for all kinds of cables, cable sheaths or cable insulations.

34. The use as claimed in claim 33, wherein the flame-retardant polymer composition is used for production of cable sheaths.

35. A cable, comprising:
A) one or more conduits, and
B) at least one layer comprising the flame-retardant polymer composition as claimed in claim 14.

36. A cable, comprising:
i) one or more conduits,
ii) at least one sheath of the conduit(s) with at least one polymeric layer,
iii) optionally at least one layer of separating agent on the sheath of the conduit(s),
iv) optionally at least one layer of shielding material,
v) optionally filling elements introduced between the conduits i), the one or more sheaths or layers ii), iii) or iv), and
vi) optionally an outer shell with at least one polymeric layer,
with the proviso that at least one of the polymeric layers comprises the flame-retardant polymer composition as claimed in claim 14.
